(19) United States
(12) Patent Application Publication
(10) Pub. No.: US 2021/0042800 A1
(43) Pub. Date: Feb. 11, 2021

(54) SYSTEMS AND METHODS FOR PREDICTING AND OPTIMIZING THE PROBABILITY OF AN OUTCOME EVENT BASED ON CHAT COMMUNICATION DATA

(71) Applicant: HEWLETT PACKARD ENTERPRISE DEVELOPMENT LP, Houston, TX (US)

(72) Inventors: SWARUP CHANDRA, San Jose, CA (US); XIN ZHANG, Houston, TX (US); ERIC HOSHANG PAGDIWALLA, Bangalore (IN); SHAILENDRA K. JAIN, San Jose, CA (US); VINUTHA BABU, Bangalore (IN)

(21) Appl. No.: 16/533,115

(22) Filed: Aug. 6, 2019

(51) Int. Cl. G06Q 30/02; H04L 12/58; G06N 3/08

(52) U.S. Cl. CPC G06Q 30/0281; G06N 3/08; H04L 51/02

(57) ABSTRACT

Systems and methods are provided for predicting and optimizing the probability of an outcome event. In a specific embodiment, the disclosure is directed to a multi-phase communication system configured to perform predictive analyses during stages based on input received from a user. In a particular implementation, there may be a first communication phase configured to accept limited input from a user to establish linear dependency between input and an outcome event for the purpose of an agent assignment, followed by a second communication phase to provide sequential predictive analyses based on natural conversation data between a user and agent. In a specific embodiment, the second communication phase may implement a second predictive model trained to identify non-linear dependencies between communication data and an outcome event. Herein is also described a graphical user interface for representing scores corresponding to the probability of outcome events, among other features.

### DESCRIPTION OF RELATED ART

Sales optimization can refer to maximizing a sales team's financial performance by deploying resources, people, and technology to achieve maximum efficiency and minimize wasted effort. Companies often utilize agents or employees as a communication interface between an organization, such as a company, and outside entities, such as potential customers. Agents may be trained to interact with a customer over a communication environment by addressing their needs and ascertaining whether there is an opportunity for a sale. For example, sales agents may assist customers in making purchasing decisions through a messaging environment and may subsequently receive purchase orders from those customers. Similarly, agents may assist customers in solving problems with products or services provided by the organization, which sometimes results in the generation of sales lead.

Agents are typically responsible for identifying key criteria to qualify the purchasing intent of a potential customer based on the content of a conversation. However, agents may have difficulty driving a conversation to generate a sales-lead because they are not able to effectively or precisely ascertain a potential customer's intentions during a conversation. Accordingly, agents are unable to determine whether and at what time a customer may have an interest in making a purchasing decision, and are thus unable to effectively implement or modify a sales strategy targeted to the individual customer.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example system architecture for an system for predicting and optimizing the probability of an outcome event, in accordance with the embodiments disclosed herein.

FIG. 2 is an example method for a system for predicting and optimizing the probability of an outcome event, in accordance with the embodiments disclosed herein.

FIG. 3 is an example method performed by a first communication phase component, in accordance with the embodiments disclosed herein.

FIG. 4 is an example embodiment communication environment of a first communication phase, in accordance with the embodiments disclosed herein.

FIG. 5 is an example of text pre-processing process, in accordance with the embodiments disclosed herein.

FIG. 6 is an example of a first predictive model, in accordance with the embodiments disclosed herein.

FIG. 7 is an example method performed by a second communication phase components, in accordance with the embodiments disclosed herein.

FIG. 8 is an example chat messaging flow diagram, in accordance with the embodiments disclosed herein.

FIG. 9 is an example chat messaging flow diagram comprising a feedback component, in accordance with the embodiments disclosed herein.

FIG. 10 is an example of a second predictive model, in accordance with the embodiments disclosed herein.

FIG. 11 is an example a graphical user interface comprising a probability tracker, in accordance with the embodiments disclosed herein.

FIG. 12 is an example computer system that may be used to implement various features of embodiments described in the present disclosure.

The figures are not exhaustive and do not limit the present disclosure to the precise form disclosed.

### SUMMARY OF THE INVENTION

The present disclosure relates to systems and methods for predicting and optimizing the probability of one or more outcome events based on message data. In certain implementations, the message data may be received as input during multiple, distinct communication phases between a first entity, such as a potential customer, and a second entity, such as a company or an agent. Further, the one or more outcome events may correspond to a purchasing decision by the first entity, such as the first entity purchasing or expressing interest in a product.

In embodiments of the disclosure, the method may comprise initiating a first communication phase. The first communication phase may comprise opening a chat environment configured to receive text input from the first entity. The first communication phase may comprise receiving text input from the first entity corresponding to one or more specific information requests from the second entity. The one or more information requests from the second entity may comprise, for example, a static form to be completed by the first entity. As disclosed herein, limiting the input received during the first communication phase may create efficiencies in the allocation of agent resources and preserve computing resources by effectively assigning potential customers to communication agents before higher order predictive models are implemented to analyze complex conversational content.

The first communication phase may comprise applying text preprocessing to the input received during the first communication phase and extracting one or more of the first features from the preprocessed first communication phase text input using various text pre-processing and feature extraction techniques disclosed herein. Features may additionally be extracted from external contextual information that may be based on the behavior or activity of the first entity during the first communication phase.

The method may comprise determining, by applying a first predictive model, one or more first scores corresponding to the probability of one or more outcome events based on one or more features extracted during a first communication phase. In implementations of the disclosure, the first predictive model may be first order predictive model, such as a logistic regression model, trained to identify linear dependencies between one or more of the first features and one or more of the outcome events.

The method may further comprise assigning, by the second entity, the first entity to a conversation agent based on one of the one or more first scores. As disclosed herein, assigning the first entity to the conversation agent may be based on whether one or more of the first scores exceeds a predefined threshold or the availability of the agent to interact with the first entity.

The method may further comprise initiating a second communication phase between the first entity and the agent. The second communication phase may comprise enabling a chat environment between the first entity and the agent configured to receive text input from the first entity. In embodiments, the second communication phase may further comprise receiving second communication phase text input from the first entity in the form of one or more sequential messages responsive to one or more messages from the agent, applying text preprocessing to the second communication phase text input, and extracting one or more of the second features from the preprocessed second communication phase text input.

The method may comprise determining, by applying a second predictive model, one or more second scores corresponding to the probability of one or more of the outcome events based on one or more second features extracted during the second communication phase. As disclosed herein, the second communication phase may comprise a free form conversation between the agent and the first entity, whereby each sequence of messages is analyzed for a correlation to one or more outcome events. In implementations of the disclosure, determining one or more second scores corresponding to the probability of one or more of the outcome events may comprise receiving a first text input from the first entity, extracting one or more of the second features from the preprocessed first text input, and applying the second predictive model to determine one or more of the second scores based on the extracted second features of the first text input. In specific implementations, the second predictive model may be a hierarchical neural network trained to identify non-linear dependencies between one or more of the second features and one or more of the outcome events.

In implementations, disclosed is a graphical user interface component configured to display, on the graphical user interface, one or more representations of one or more of the first scores and one or more of the second scores. In embodiments, the graphical user interface may provide an agent with various interactive tools for understanding determined probability scores, analyzing the effect of a sales strategy, facilitating feedback, and increasing the probability of one or more outcome events.

For example, disclosed herein is a recommendation component configured to recommend, to the agent during a communication phase or stage, one or more items corresponding to a sales strategy. For example, recommendation component may be configured to recommend during a sales opportunity phase one or more information items to obtain from the first entity relating to the budget of the first entity, the authority of the first entity to make a purchase, the authority of the first entity to make a purchase, and time period for which the first entity needs one or more products. In certain embodiments, the recommendation component may be configured to recommend one or more products to recommend for purchase by the first entity based one or more scores as disclosed herein.

In implementations, disclosed is feedback component configured to receive input corresponding to the actual occurrence of an actual outcome event or to the probability of an outcome event. In implementations, the feedback component may be configured to receive input from the agent during the second communication phase corresponding to the probability of one or more outcome events, receive input corresponding to the actual occurrence of one or more outcome events, and received input as feedback to the first predictive model or the second predictive model. As disclosed herein, the feedback component may facilitate the training of one or more predictive models.

The second communication phase may be further configured to initiate a sales opportunity communication phase after one or more of the second scores exceed a defined threshold. In such implementations, an opportunity phase may correspond to a high degree of likelihood that the first entity may make a purchasing decision.

### DETAILED DESCRIPTION

As alluded to above, conventional solutions for improving sales are typically limited to merely improving the overall quality, rather than optimizing the probability of a lead by increasing agent attention on the changing probability of a lead. Typical solutions involving communication agents do not optimize agent assignments using a multi-phase predictive model approach. Moreover, existing solutions focus entirely on individual chat conversations as a single channel of sale.

The present disclosure solves the shortcomings of prior solutions by implementing multiple, sequential communication phases designed to determine and optimize the probability of one or more outcome events. Furthermore, the present disclosure utilizes data from multiple communication channels and customers to improve models that provide relevant information to chat agents resulting in increased consistency and complementary marketing effort across all sales channels.

Disclosed herein are methods and systems for determining and optimizing the probability of a sale based on communication input received from a potential customer. According to certain embodiments, a potential customer may enter a first communication phase configured to receive specific, predetermined information items from the customer. For example, the first communication may comprise a digital form or a series of specific questions designed to obtain certain information items that may be correlated to the generation of a sales lead. In the first communication phase, a predictive model may analyze features extracted from the input received by the customer to determine correlations to one or outcomes, such as the likelihood of a sales lead or opportunity. In implementations, the potential customer may be assigned to a chat agent based on the determinations made during the first communication phase.

The potential customer may then enter a second communication phase with the assigned chat agent. In contrast to the first communication phase, the second communication may consist of a natural message-based conversation between the potential customer and the assigned chat agent. A predictive model may be implemented to determine the probability of a sales lead or opportunity after each sequential communication during the conversation. In implementations, the predictive model may determine message-level or conversation-level correlations to a sales lead or opportunity.

In embodiments, disclosed herein is a graphical user interface program configured to enhance a sales chat agent attention and strategy in monitoring and generating a sales lead. For example, a probability tracker may be implemented to visually represent to the chat agent the real-time probability of a sales lead during the duration of a conversation. The graphical user interface program may also provide one or more tools designed to increase agent effectiveness, such as a session management component, a response recommendation component, product recommendation component, and a feedback component. As described herein, the various benefits of the graphical user interface program may including enabling an agent to observe the effectiveness of a sales strategy, implement or modify a sales strategy, or provide useful feedback narrowly tailored to improve the performance of a predictive model.

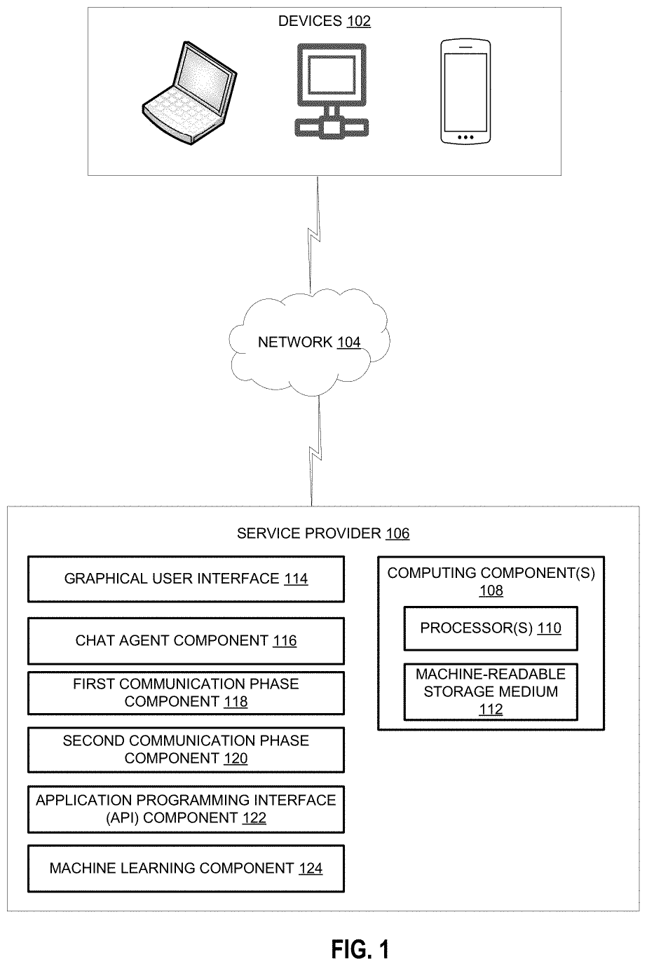

FIG. 1 illustrates an embodiment of a system architecture 101 for performing the various systems and methods described herein. The system architecture may comprise one or more devices 102, a network 104, and a service provider 106. In some implementations, the one or more devices 102 may be operated by one or more users, a first entity, a second entity, and an agent as described herein. Each of the one or more devices 102 may comprise a desktop computer, laptop, mobile device, tablet, or any other type of user device that may have the capability of connecting to network 104.

Network 104 may comprise a wired or wireless network such as the Internet, an intranet, a LAN, a WAN, a cellular network or another type of network. It will be understood that network 104 may be a combination of multiple different kinds of wired or wireless networks. Network 104 may connect to the service provider 106 and allow for communication between the one or more devices 102 and the service provider 106. In some implementations, a plurality of devices associated with one or more users or the service provider may be connected via network 104.

Service provider 106 may comprise a computing component 108. Computing component 108 may comprise one or more processors 110 and a machine-readable storage medium 112. As described herein, the various operations and functions performed by service provider 106 may be performed by one or more of a first communication phase component 120, a second communication phase component 120, a chat agent component 116, and/or other components disclosed herein. In certain implementations, service provider 106 may be associated with a second entity, a company, a service line, a sales team, or any other group of persons and/or devices.

Processor 110 may be one or more central processing units (CPUs), semiconductor-based microprocessors, and/or other hardware devices suitable for retrieval and execution of instructions stored in machine-readable storage medium 112. Hardware processor 110 may fetch, decode, and execute instructions, to control systems and methods for predicting and optimizing the probability of one or more outcome events based on message data. As an alternative or in addition to retrieving and executing instructions, hardware processor 110 may include one or more electronic circuits that include electronic components the functionality of one or more instructions, such as a field programmable gate array (FPGA), application specific integrated circuit (ASIC), or other electronic circuits.

A machine-readable storage medium, such as machine-readable storage medium 112, may be any electronic, magnetic, optical, or other physical storage device that contains or stores executable instructions. Thus, machine-readable storage medium 112 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 112 may be a non-transitory storage medium, where the term “non-transitory” does not encompass transitory propagating signals. As described in detail below, machine-readable storage medium 112 may be encoded with executable instructions, for example, the instructions illustrated in the figures below . Depending on the implementation, the instructions may include additional, fewer, or alternative instructions performed in various orders or in parallel. Machine readable storage medium may be stored in different physical storage devices but may be operable to perform functions together.

Service provider 106 may comprise a graphical user interface 114, a chat agent 116, a first communication phase component 118, a second communication phase component 120, an application programming interface (API) component 122 and a machine learning component 124. The various processes, tasks, and methods performed by the components as described herein, may be performed by one or more devices separate from the service provider 106.

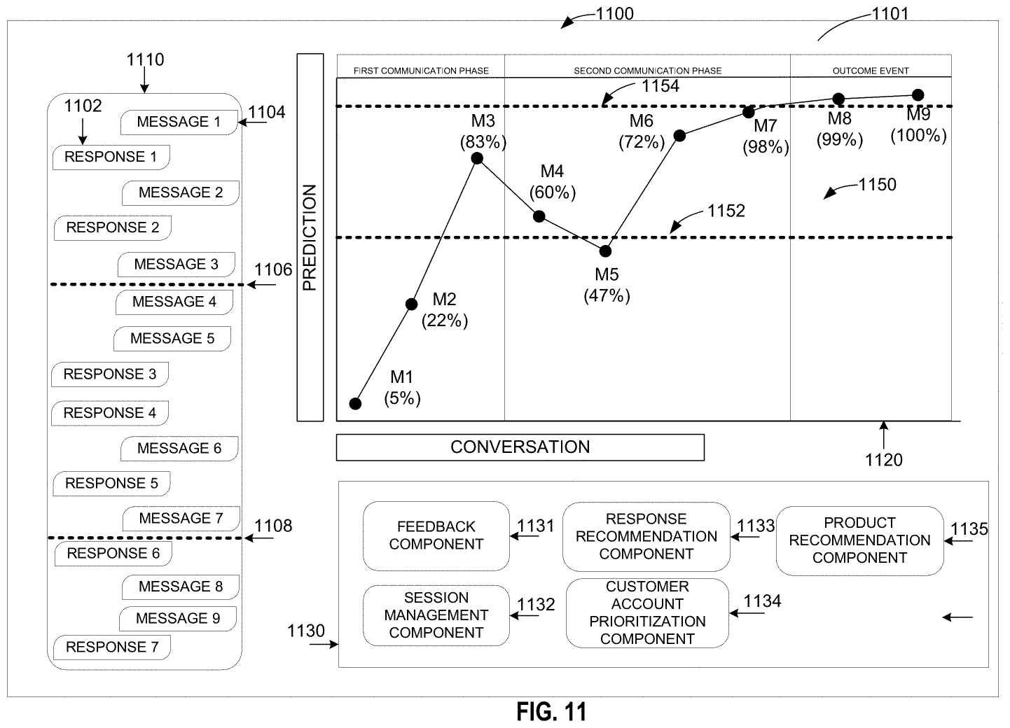

Graphical user interface (GUI) 114 may comprise a device that allows a user to interact with the one or more devices 102. GUI 114 may include, but is not limited to being, a display screen, touch screen, a physical keyboard, a mouse, a camera, a video camera, a microphone, and/or a speaker. GUI 146 may be configured to receive inputs associated with the one or more devices 102 and other service provider 106 components and render displays accordingly. For example, graphical user interface 114 may comprise a graphics processing unit, or any other programmable logic chip for rendering displays, images, animations and video. The input data received by the GUI may be transmitted to the one or more devices 102 over network 104. The GUI 114 may be configured to generate the agent GUI as discussed herein with respect to FIG. 11.

API component 122 may be configured to provide interaction specifications between one or more of the service provider components. API component 122 may comprise a set of functions, parameters, or procedures for allowing one or more applications, programs, models, or components as described herein to access the features or data of an operating system, application, component, or other service. API component 122 may include, but is not limited to, functions, sub-routine definitions, and/or communication protocols for interaction between the components of the service provider components. API component 122 may be configured to provide interaction specifications between the service provider 106 and network 104. For example, API component 112 may be configured to send data obtained during a communication phase to be processed by one or more of the predictive models.

In some embodiments machine learning component 124 may perform predictive analysis for the first communication phase component 118 and second communication phase component 118. Machine learning component 124 may comprise one or more algorithms, mathematical models, statistical models, or computer systems configurable to identify patterns, determine correlations, and make inferences based on input data. For example, machine learning component 124 may be configured to apply a predictive model to input data received from the first communication phase component 118 or second communication phase component 120. Machine learning component 124 may be suitably trained on historical communication data to optimize, train, or modify the various predictive models described herein.

The components of the systems and methods described herein may comprise, for example, executable computer code configured to perform the functions as described herein. Components may be integrated or separated. Moreover, the operations of the systems and methods disclosed herein may be performed by more, fewer, or other components and the methods described may include more, fewer, or other steps. Additionally, steps or operations described herein may be performed in any suitable order.

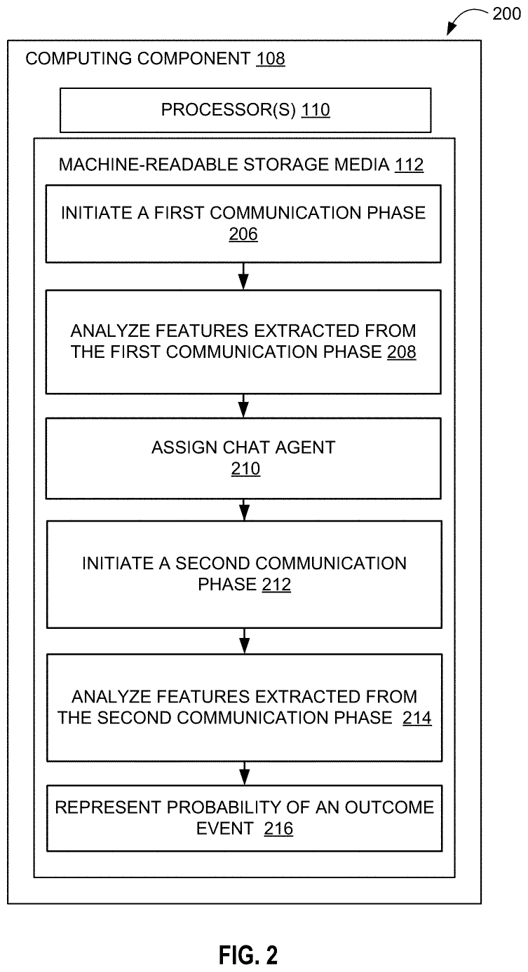

FIG. 2 illustrates a high-level block diagram of an example of a method 200 for determining the probability of an outcome event based on communication data, in accordance with one or more implementations of the disclosure. The method may be performed by one or more computing components 108, one or more processors 110, and a machine-readable storage medium 112. The systems and methods herein may be described to comprise one or more communication phases. As used herein, a communication phase may refer to a series of events, actions, or functions involving the first entity that occur for a certain time period, or for a duration of time for which conditions required for a phase change are not met. For example, a first communication phase may start from the moment a user is able to access an input environment and end after the user has been assigned to a chat agent. Further, a second communication phase may start after a chat agent is assigned to the user and end after a chat session has expired. However, the various functions and processes of the communication phases should not be constrained to be performed in any specific order. A chat session may expire at the selection of the user or the agent, or may automatically be terminated after one or more conditions are met, such as the sale of a product. In some implementations, certain aspects of the agent assignment may occur within a first communication phase, the second communication phase, or both. As described herein, a session may refer to a continuous period of time for which a user may be engaged with an agent.

In some embodiments, processor(s) 110 may execute instruction 206 to initiate a first communication phase. A first communication phase may be initiated between a first entity and a second entity. As used herein, a first entity may be a user, customer or chat bot that may be in communication with a second entity through the various communication phases described herein. In some embodiments, the second entity may be a service provider, an agent, customer services or sales representative, a third party representative, or other representative of a company with which the first entity may engage to receive information related to question, a sales need, a technical problem, or an inquiry. In an implementation, a first entity may be a customer and the second entity may be a company configured to provide services or products to the first entity. The first entity may have an associated customer account with associated identification, demographical, behavioral information that may be used as input for the various determinations or processes described herein.

In implementations of the disclosure, the first communication phase may comprise an input environment configured to receive input from a user, such as text input or a selection of one or more options. In a specific embodiment, the input environment may comprise a digital form or a message field. A first communication phase may be pro-actively initiated by the second entity. For example, the first communication phase may be initiated by the second entity at the direction, command, or request of the second entity. In one implementation, the second entity may initiate a first communication phase by generating a chat environment on a display of the first entity's device. In alternative implementations, a first communication phase may be reactively initiated by the second entity. For example, the first communication phase may be initiated by the second entity at the direction, command, or request of the first entity. In a specific implementation, the first entity may choose to enter a chat environment by selecting one or more icons representing an option to enter into a communication phase with the second entity. Upon the receipt of the user input, the second entity may initiate the first communication phase.

In implementations of the disclosure, the first communication phase may comprise opening a chat environment configured to receive input from the first entity. In certain embodiments, a chat environment may be a messaging portal, chat window, or other similar environment configured to receive text input from the first entity. In various embodiments, the chat environment may be configured to receive input from one or more user devices through a keyboard or other forms of manual text input. In alternative embodiments, the chat environment may be configured to receive voice information corresponding to a text input (e.g., voice to text). In certain implementations, the chat environment may be configured to receive input corresponding to one or more user selections.

In implementations of the disclosure, the first communication phase may further comprise receiving input from the first entity corresponding to one or more information requests from the second entity. In accordance with the present disclosure, the second entity may communicate one or more predefined information requests corresponding to the user's intent in engaging with the second entity, a problem or type of problem the first entity is experiencing, the party or type of party the first entity wishes to communicate with, or a generalized inquiry regarding the intention(s) of the first entity. As disclosed herein, a party's intent may refer to a determined probability that an outcome event involving the party may occur.

In some embodiments, processor(s) 110 may execute instruction 208 to analyze features extracted from the first communication phase. As used herein, a feature may refer to characters, words, and information received during one or more communication phases, including numerical representation of the characters, words, or information. In implementations, features may first be extracted from one or more of input received during the first communication phase and external contextual information. In implementations, external contextual information may be information may relate to the first entity, but may be external to a specific chat environment.

In implementations, features extracted from the first communication phase may be analyzed by a first predictive model to determine one or more scores corresponding to the probability of one or more outcome events as in operation 216. In implementations of the disclosure, the first predictive model may be received as input one or more features extracted from the first communication phase to determine the probability of one or more outcome events. In implementations, one or more probabilities determined by the predictive model may be represented as scores that may be stored by, presented to, or otherwise accessible by the second entity. A predictive model may be used to determine one or more scores corresponding to the probability of one or more outcome events.

In various embodiments, the predictive model may be trained to identify linear dependencies between one or more of the features extracted from the first communication phase and one or more of the outcome events. In various embodiments, the predictive model may also be trained to identify linear dependencies between features extracted from the first communication phase and one or more outcome events. Non-limiting examples of outcome events include one or more of the following: the first entity making a purchase; the first entity purchasing a specific product; the first entity making a purchase having a value above a defined threshold; and the first entity purchasing a product within a defined class of products.

In some embodiments, processor(s) 110 may execute instruction 210 to assign the first entity to a conversation agent based on one or more of the first scores determined by the predictive model. In implementations, the agent assignment may be dependent on the availability of the agent to interact with the first entity. In embodiments, the agent assignment may depend on one or more scores determined by the predictive model that may relate to a skill set or area of expertise of one or more agents.

In operation 212, a second communication phase may be initiated between the first entity and one or more agents assigned to the first entity. In implementations of the disclosure, the second communication phase may comprise a chat environment configured to facilitate real-time communication between the first entity and the agent. In example embodiments, the first entity and the agent may communicate using text-based messages, audio messages, or video messages. In embodiments, the second communication phase component may enable a chat environment between the first entity and the agent configured to receive text input from the first entity and to provide text output from the agent. For example, the first entity may provide text input in the form of a message to the agent and receive outputted text in the form of a response from the agent. In some implementations, the second communication phase may comprise a plurality of stages corresponding to the progress of the second communication phase. In example embodiments, features extracted during the second communication phase may have different correlations to one or more outcome events based on the stage from which they were extracted.

In embodiments of the present disclosure, the second communication phase may comprise extracting one or more features from input received during the second communication phase. In implementations, features may be extracted from individual messages from the first entity or the agent. In some implementations, text-preprocessing may be applied to the messages communicated during the second communication phase to facilitate feature extraction.

In some embodiments, processor(s) 110 may execute instruction 214, to analyze features extracted from the second communication phase. In implementations, features may correspond to conversation or message data received during the first communication phase. Similar to the first communication phase, the features of the second communication phase may also comprise external contextual information.

As discussed herein, a second predictive model may be applied in operation 214 to determine one or more scores corresponding to the probability of one or more of the outcome events based on one or more second features extracted during the second communication phase. In implementations, the second predictive model may be configured to determine a score based on features contained within individual messages exchanged between the first entity and the agent. In implementations, the predictive model may be further configured to analyze features contained within two or more sequential or non-sequential messages exchanged between the first entity and the agent.

The second predictive model may be trained to identify non-linear dependencies between one or more of the second features and one or more of the outcome events. In various embodiments, and as discussed in more detail below, the second predictive model may comprise a hierarchical neural network utilizing Long-Short Term Memory (LSTM) units to capture the long and short-term dependency among words and/or features that occur sequentially in a sentence, a plurality of sentences, or across two or more individual messages.

In some embodiments, processor(s) 110 may execute instruction 216, to represent the probability of an outcome event. For example, during a first and second communication phase. In various implementations, the probability of an outcome event may be represented to an agent using an agent graphical user interface, as described herein, to increase agent attentiveness and inform the implementation or modification of a sales strategy, resulting in an increase in the probability of an outcome event, such as generating a sales lead. The probability of an outcome event may be determined and represented at one or more different times during method 200. For example, the probability of an outcome event may be updated and represented after each sequential communication between one or more of the first entity, the second entity, and the agent using one or more of the communication environments of the first and second communication phases.

In implementations, one or more scores corresponding to the probability of one or more event outcomes may be categorized, generalized, or grouped into a score type based on their relative magnitude. In implementations, scores that exceed a first threshold may be categorized, generalized, or grouped together, while scores that exceed a second, higher threshold may be grouped separately. In a non-limiting example, an outcome event may be defined as the first entity purchasing a product. In such implementations, one or more scores determined in the various steps of method 200 may correspond to the probability of a sale based on features extracted from the first and second communication phase. In an embodiment, if a determined score exceeds a first threshold (e.g., 50%), the first score may correspond to a “lead.” Further, if a determined score exceeds a second threshold (e.g., 95%), the score may correspond to a “opportunity.” In implementations, the score and the score type may inform the sales agent as to the probability of the outcome event. In various implementations, and as discussed further below, one or more of the score and the score type may influence the agent's sales technique, strategy, or approach through various component of an agent graphical user interface or feedback mechanism in order the increase the probability of one or more outcome events.

In accordance with the disclosure, utilizing a first predictive model during a first communication phase to determine the probability of one or more outcome events before entering a second, distinct communication phase may yield various advantages over prior solutions. First, in implementations involving a first predictive model trained to identify linear dependencies between features and outcome events, computational resources and human resources are conserved by identifying early on which first entities (i.e., customers) demonstrate a high probability of an outcome event (i.e., the purchase of or interest in a product) based on specific information requests before assigning the entities into a second communication phase (i.e., a service line or messaging portal), which may require a predictive model trained to identify non-linear dependencies between features and outcome events. Categorizing customers based on probabilites determined after the first phase may allow the second entity to effectively prioritize agent assignment and allocate computational resources and human resources to those customers whose intent may be less understood, or customers whose purchasing decision may be dependent on an optimal agent assignment or agent experience based on the determined probabilities and one or more attributes, characteristics, skill sets, or areas of expertise of the customer or agent. Thus, through a multi-communication phase approach and intelligent agent assignment, the system and methods described herein conserve computational resources and human resources in systems designed, for example, to handle a large number of customer requests or inquiries, some of which that may be completely unrelated to the sale of a product.

Another major advantage of the present disclosure with respect to sales-related embodiments is to direct customers after the first communication phase with non-sales related queries to an agent trained to offer information or support. Additionally, a customer may be transferred to a different agent during the second communication phase after a determination that the probability of a sale has decreased below a certain threshold or the customer is determined to be in need of product support rather than a making a purchase. Thus, the present disclosure increases customer satisfaction and reduces sales overhead in handling non-sales related queries.

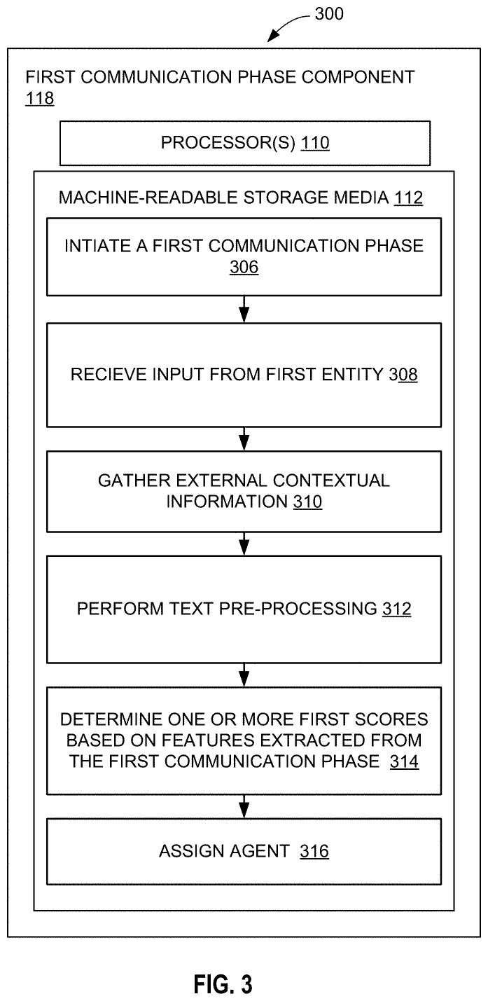

FIG. 3 illustrates an example embodiment of a method 300 that may be performed by first communication phase component 118. In an embodiment, the method may be performed by one or more computing components 108, one or more processors 110, and a machine-readable storage media 112.

In some embodiments, processor(s) 110 may execute instruction 306 to initiate a first communication phase between a first entity and a second entity. In implementations, a first communication phase may be pro-actively initiated by the second entity. For example, the first communication phase may be initiated by the second entity at the direction, command, or request of the second entity. In a various implementations, the second entity may initiate a first communication phase by generating a chat environment on a display of the first entity's device. In alternative implementations, a first communication phase may be reactively initiated by the second entity. For example, the first communication phase may be initiated by the second entity at the direction, command, or request of the first entity. In various implementations, the first entity may express intent to enter into a communication phase with the second entity by selecting one or more icons representing an option to enter into a communication phase with the second entity. Upon the receipt of the user input, the second entity may initiate the first communication phase.

In some embodiments, processor(s) 110 may execute instruction 308 to receive input from the first entity corresponding to one or more specific information requests from the second entity. For example, an information request may comprise a digital form comprising one or more questions to be answered by the first entity. For example, the form may present the question: “How may we help you?” In such an example, the first entity may be presented with an option to provide input in the form of a selection of one or more responses to the second entity's information request, such as (1) “I need Technical Support”; (2) “I would like to speak to a Sales agent”; (3) “I need a quote on a product.” In other embodiments, the first entity may provide text input 408 responsive to the second entity's information request. For example, the second entity may provide the following as an information request: “How may we help you?” In such a case, the first entity may provide input responsive to the information request. In implementations, a series of scripted or programmed questions or messages may be presented by the second entity to the first entity corresponding to one or more information requests.

In various embodiments, options to provide input in the form of a selection of one or more responses to the second entity's information request may be provided in combination in series or in parallel with one or more options to provide text input. As described herein, receiving input from the first entity corresponding to one or more specific information may result in accurate correlations between the received input and the outcome event, thus creating computational efficiencies by making determining an agent assignment before higher order predictive models may be applied.

An information request during the first communication phase, as used herein, does not necessarily require an explicit question from the second entity. Rather, and as would be appreciated by a person having skill in the art, an information request during the first communication phase may comprise any communicative interaction between the first entity and the second entity that may correlate to one or more outcome events.

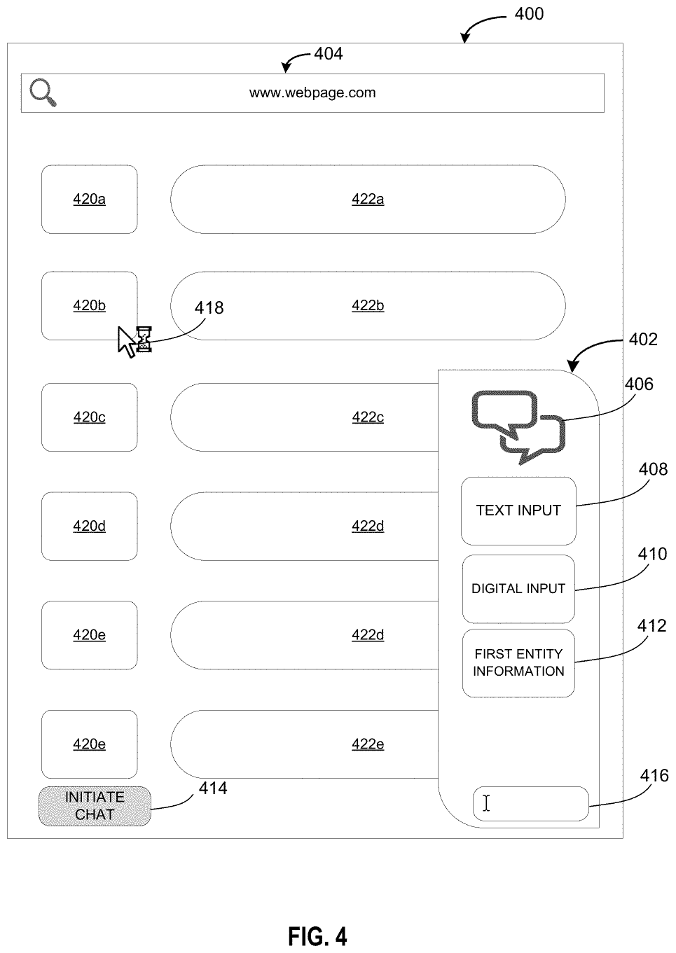

In some embodiments, processor(s) 110 may execute instruction 310 to gather external contextual information. In implementations, external contextual information may comprise information corresponding to the first entity that originates externally from a specific chat environment. For example, contextual information may comprise information that is not input data received by a dedicated communication environment, but information that may be associated with a behavior or action of the first entity and that may be correlated to one or more outcome events. In an example embodiment, contextual information may correspond to the first entity's web browsing activity, text contained or displayed within a web page that the first entity has visited during or before the first communication phase, and/or images contained or displayed within a web page that the first entity has visiting during or before the first communication phase. In implementations, contextual information may be extracted and/or gathered in real-time during one or more of communication phases described herein based on the dynamic activity of the first entity. For example, and with respect to FIG. 4, contextual information map comprise information related to position information of cursor 418. In certain implementations, contextual information may comprise information corresponding to the first entity's engagement with one or more elements 420 and 422 of a webpage. For example, contextual information may relate to the number or degree of interactions between a cursor 418 and one or more elements 420 and 422 of a webpage. In implementations, and as discussed in more detail below, various text pre-processing techniques may be applied to external contextual information to facilitate or perform the extraction of one or more of the features.

External contextual information may gathered and analyzed before a first communication phase. In implementations, external contextual information may be analyzed, in accordance with the methods described herein, to understand a first entity's intent in entering the first communication phase. For example, a first entity's activity on a Frequently Asked Questions (FAQ) page, or relevant web pages related to non-sales queries, support, or specific products may be analyzed to determine a customer's intent prior to the first communication phase, which may influence or optimize the specific information items collected during the first communication or a subsequent agent assignment.

In some embodiments, processor(s) 110 may execute instruction 312 to apply one or more text pre-processing techniques to input received during the first communication phase. In operation 312, one or more text pre-processing techniques may also be applied to at least a portion of the external contextual information received during the first communication phase. The sentences or words used by the first entity or contained within the external contextual information may not be in a standard form. For example, input may contain typing-errors, slang words, acronyms, and other non-standard word forms that may have a negative effect on the statistical relationship with one or more outcome events determined by a predictive model. In implementations of the disclosure, input or information may be pre-processed before being analyzed by one or more of the predictive models described herein. In implementations of the disclosure, various text-preprocessing techniques (i.e., natural language processing (NLP)) may be applied for the purpose of facilitating the extraction of one or more features from information received during one or more communication phases.

As discussed herein, NLP can be generally described as multiple theory-driven computational techniques for the automatic analysis and representation of human language. NLP, referred to herein, may be processes that involve computers performing a wide range of natural language related tasks at various levels, such as parsing, and pattern recognition. Recent advancement in deep learning, for instance applying neural networks for dense vector representations, has further improved some NLP-based tasks. Closely related to this trend of deep learning within NLP is the concept of word embeddings.

In some approaches, NLP can be used to model complex natural language tasks. A drawback of some traditional NLP-based modeling techniques involves dimensionality. Dimensionality is often associated with challenges that are characteristic of analyzing and organizing data in high-dimensional spaces (often with hundreds or thousands of dimensions). This led to the emergence of models that learn distributed representations of words existing in low dimensional space, including embeddings. Embedding techniques (e.g., character, word, sentence, and paragraph) have been used for dimensionality reduction and sematic deduction to improve accuracy and performance improvements of NLP modes. Generally, embedding techniques have been employed to understand word relationships in a document or “corpus.” As referred to herein, a corpus can be defined as a body of words within a text or collection of texts. Accordingly, an advantage of embedding (e.g., distributional vectors) is its ability to capture similarities between words. Furthermore, measuring similarity between vectors is possible. Embeddings, due to these characteristics, can be useful as a processing layer in a deep learning model.

As described herein, word embeddings can be described as a vector representation (e.g., vector of numbers) of a document vocabulary which is capable of capturing the context of a word in a document. Transaction records are data structures that include data related to interactions between entities within a network. For instance, text of a transaction record can be parsed to extract information linked to an interaction, such as which server within an enterprise is accessed by a particular user during a network communication. These transaction records can be subjected to text-based analysis, where the data included in each transaction record can be viewed as natural language words. Similarly, transaction records can be equivalent to sentences (referred to as network activity sentences). Thus, collecting a vast collection of data form multiple transactions over a period of time can build a “corpus” of the network activity which drives formulation of the embedding space.

Distributional vectors, or word embeddings, can be described as applying a distributional algorithm, according to which words with similar meanings tend to occur in similar context. Often times word embeddings can be derived from observing words that are grouped together, such as in a sentence. Referring to the example, words “King”, “Man”, and “Woman” may be in the same sentence (or occurring in a number of sentences observed over a period of time), where it can be assumed that the words have some level of contextual relationship due to natural language semantics and syntax. By employing word embedding techniques, each word can have its own corresponding vector representation, which can help capture contextual characteristics of the neighboring words. Similarities between the vectors can be measured by highlighted vector elements.

As an example of a natural language context, it can be ascertained that a “King” is also a “Man” based on English definitions, thus the words have some similarity. Further, adding context associated with the word “Woman” to the abovementioned relationship, word embeddings may be used to predict an occurrence of another related word. Some existing NLP-driven applications use embeddings, such as auto-completion. In the case of auto-completion, NLP tasks may train a model, applying the learned vectors to future occurrences of receiving “King”, ‘Man”, and “Woman” in context, to automatically predict an output of “Queen”, for example to complete auto-populate a search bar of web application with a complete sentence. The disclosed techniques extend the practical application even further, utilizing systems and techniques that can adapt NLP approaches to be effective in network security.

Although the system and techniques are described in reference to word embeddings, it should be appreciated that other types of embedding approaches that are applicable to NLP-based analysis, such as character embeddings, can be applied in lieu of, or in addition to, word embeddings techniques discloses herein.

In some embodiments, processor(s) 110 may execute instruction 314 to determine one or more first scores based on one or more features extracted from the first communication phase. One or more first features may be extracted from input received during the first communication phase. As discussed herein, input received during the first communication phase may comprise, for example, a communication from the first entity. In embodiments, input received during the first communication phase may comprise external contextual information. In implementations, one or more first features may comprise information directly received during the first communication phase. In alternative implementations, one or more first features may be extracted from the first communication phase using one or more text-preprocessing techniques and feature extraction techniques as discussed herein.

The one or more first features extracted from the first communication phase may be analyzed by a predictive model to determine one or more first scores corresponding to the probability of one or more outcome events. In implementations of the disclosure, the predictive model may receive as input, one or more characters, words, or first features extracted from the first communication phase to determine the probability of one or more outcome events. In implementations, one or more probabilities determined by the predictive model may be represented as one or more scores that may be stored by, presented to, or otherwise accessible by the second entity.

The predictive model of the first communication phase may comprise a predictive model trained to identify linear dependencies between one or more of the first features and one or more of the outcome events. As disclosed herein, the first communication phase may be configured to extract information from the first entity corresponding to one or more specific information requests from the second entity. As a result, information received during first communication phase may have a relatively strong statistical correlation to one or more outcome events.

The first communication phase may be configured to receive a limited amount of input data to heighten the correlation between one or more of the first features and one or more of the outcome events. In various embodiments, the median word length of text input received by the first entity during the first communication phase may be, for example, eight words. As a result, a first stage phase model trained to identify linear dependencies be may be effective in determining a preliminary correlation between information received during the first communication phase and one or more outcome events before proceeding to the second communication phase. By constraining the information exchange between the first entity and the second entity during the first communication phase, the first predictive model may reliably determine linear correlations between extracted features of the first communication phase and one or more of the outcome events for the purpose of agent assignment.

In various implementations, for example, a logistic regression model may be used to determine one or more scores corresponding to the probability of one or more outcome events. In an example embodiment, the predictive model may also be trained to identify linear dependencies between one or more features extracted from the first communication phase and one or more outcome events. Non-limiting examples of outcome events include one or more of the first entity making a purchase; the first entity purchasing a specific product; the first entity making a purchase having a value above a defined threshold; and the first entity purchasing a product within a defined class of products. In implementations, a score determined by the predictive model may correspond to the probability of one or more outcome events.

In some embodiments, processor(s) 110 may execute instruction 316, to assign the first entity to a conversation agent based on one or more of the first scores determined by the predictive model. In embodiments, the agent assignment may depend on one or more scores determined by the predictive model that may relate to a skill set or area of expertise of one or more agents. For example, in various embodiments, the predictive model may determine that there is a high probability that the first entity may purchase a certain product within a class of products. In such a case, for example, the second entity may assign the first entity to a conversation agent that is trained to handle customer requests within that class of products or the specific product.

In implementations, the agent assignment may be based on two or more of scores determined by the predictive model. To further illustrate the previous example, the predictive model may determine: that there is a high probability that the first entity may purchase a first product; a high probability that the first entity may purchase a second, different product; and a low probability that the first entity will purchase a third, different product. In such a case, a first agent with experience in handling customer interactions related to the first and second products may be prioritized over a second agent with experience in the second product and third product, but poor experience with the first product. In implementations, the agent assignment of operation 316 may depend on a combination of one or more of the first scores and one or more secondary consideration, such as the availability of the agent to interact with the first entity. In the embodiments as discussed herein, the agent assignment may be optimized to make an agent assignment that is predicted to increase the probability of one or more outcome events. In some embodiments, the completion of an agent assignment may precede the second communication phase.

In accordance with the disclosure, the first communication phase may provide insight into a potential customer's intent prior to being assigned to a chat agent in a subsequent communication phase. Establishing insight into a customer's intent by determining a probability of one or more outcome events prior to a second communication phase may inform a subsequent agent sales strategy. For example, it may be established after the first communication phase that there is a high likelihood that the potential customer may purchase a product within a class of products. As described herein, the system and methods described may optimize the probability of outcome events by, for example, recommending to the agent one or more responses or products to the potential customer based on scores determined after the first communication phase.

FIG. 4 illustrates an example embodiment of a communication environment of a first communication phase in accordance with embodiments disclosed herein. In various implementations, aspects of the first communication phase may be viewable on a user display 400 of the first entity and may be accessible through a webpage 404. In various embodiments, a first entity may access the first communication phase through one or more of a webpage, an application, a graphical user interface, a device, and/or a portal configured to communicate with a second entity.

In accordance with the disclosure, initiating the first communication phase may comprise opening a communication environment 402 configured to receive input from the first entity. As described herein, the second entity may initiate the first communication phase upon receiving input from the first entity. For example, there may exist one or more selectable options 414 to direct the second entity to initiate a communication environment 402. In certain embodiments, communication environment 402 may be a messaging portal, a chat window, a messaging environment, a digital form, a video chat, a voice chat, or other environment or window configured to receive input from the first entity.

The first communication phase component may utilize an communication environment 402 to receive input from the first entity. In certain implementations, the communication environment 402 may be configured to facilitate a message environment 406 between the first entity and the second entity. In various embodiments, the communication environment 402 may be configured to receive text input 408 from one or more user devices through a keyboard or other forms of manual text input. For example, communication environment 402 may comprise a message field 416 configured to receive free form text input from the first entity. In alternative embodiments, the chat environment 402 may be configured to receive voice information corresponding to a text input (e.g., voice to text). In implementations, the communication environment 402 may comprise a video chat.

The communication environment 402 may comprise a digital form. A digital form of communication environment 402 may be configured to receive text input 408 and digital input 410 from the first entity. In various implementations, for example, a digital form may comprise a representation of a template on a graphical user interface. In an embodiment, the first entity may manually select one or more icons representing responses to one or more information requests from the second entity. In certain implementations, the first entity may provide input to the digital form using a cursor 418 or through a touch screen device.

The communication environment 402 may be configured to receive input from the first entity corresponding to one or more specific information requests from the second entity. In an example embodiments, the second entity may communicate one or more predefined information requests corresponding to one or of the user's intent in engaging with the second entity, a problem or type of problem the first entity is experiencing, the party or type of party the first entity wishes to communicate with, identification information, or a generalized inquiry as to the intent of the first entity.

Communication environment 402 may be configured to receive identification, demographical, behavioral, or historical information 412 of the first entity. For example, the first entity may provide one or more of a name, a user name, a password, or other identification information. In implementations, the identification information may correspond to a user profile or customer account. In embodiments, the user profile may be associated with stored information corresponding to one or more interactions between the first entity and the second entity. For example, a user profile may have information corresponding to a history of purchases or behaviors of the first entity. As discussed herein, the user information associated with the first entity may inform one or more predictive models as to the probability of one or more outcome events.

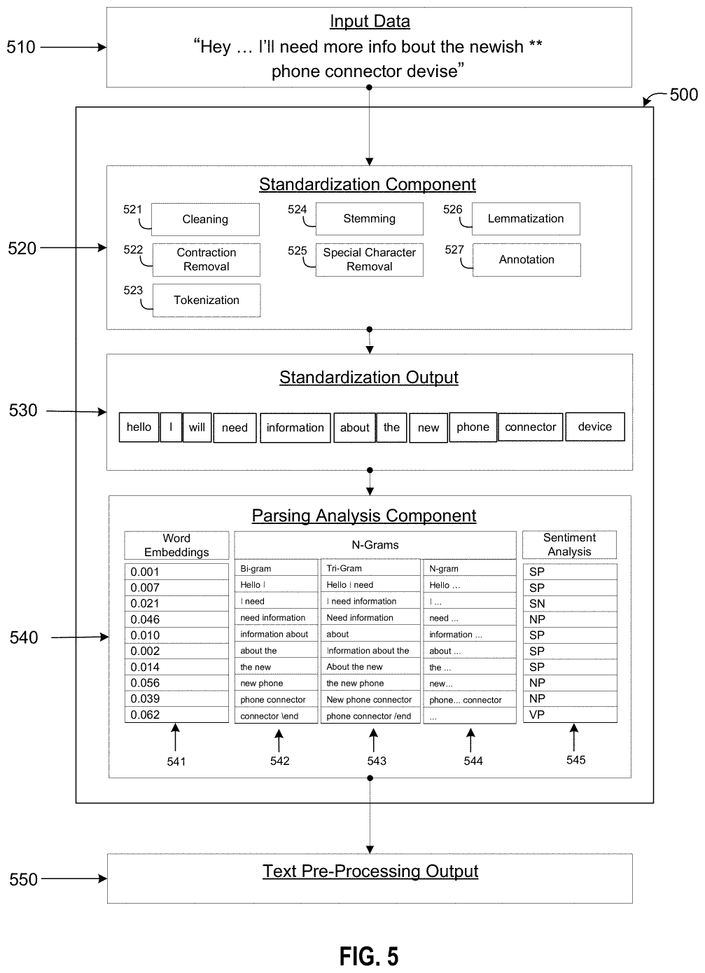

FIG. 5 illustrates an example of text pre-processing by text pre-processing component 500 in accordance with the embodiments disclosed herein. Text pre-processing component 500 may comprise a processing component 520, a text processing output 530, and a parsing analysis component 540. Input to the text pre-processing component may comprise input data 510. Output of the text pre-processing component 500 may comprise text pre-processing output 550. In implementations, example text pre-processing may comprise one or more steps to organize input data or information received during one or more communication phases such that it can be received as input by one or more predictive models, as disclosed herein.

Input data 510 may comprise a user interaction captured in a web-based application. In one configuration, the input data 510 may be in the form of a text input received in a window in a web application, such as communication environment 402. In other configurations, input data 510 may comprise external contextual information, as described herein. For example, one or more words, sentences, image data, or features of a webpage may form input data 510 that may be processed by text pre-processing component 500. In embodiments, the input data 510 may be received by a standardization component 520.

The standardization component 520 may include one or more specific text pre-processing techniques for language standardization. For example, standardization component 520 may comprise at least a cleaning technique 521, a contraction removal technique 522, a tokenization technique 523, a stemming technique 524, a special character removal technique 525, a lemmatization technique 526, and an annotation technique 527. In implementations, standardization component 520 may utilize one or more NLP text pre-processing known by those of ordinary skill in the art.

The cleaning technique 521 may comprise editing at least a portion of input data to remove nonstandard characters. For example, cleaning technique 521 may comprise removing punctuation, numerical values, or other nonstandard characters that may bear little statistical significance to one or more outcome events. In implementations, cleaning technique 521 may comprise correcting misspelled words. In certain configurations, the cleaning text pre-processing technique 521 may remove HTML code from input data 510 that is in the form of a html-based web application object. For example, text elements associated with displayed the content on a web page, such as “<div>” and “<html>”, may be removed to reduce the amount of information not directed to the displayed content itself. In implementations, cleaning technique 521 may take the form of a regular expression that is used to filter out the specified text to remove punctuation and fix commonly mis-spelled words. A regular expression, for example, may be a sequence of characters that define a search pattern commonly used in string searching algorithms. In the example illustrated in FIG. 5, cleaning technique 521 may remove from input data 510 the “ . . . ” and “**”, replace the term “info” with the term “information,” and replace the word “devise” with “device,” resulting in a modified text output 530.

The contraction removal technique 522 may remove contractions from the input data 510. For example, contractions may be expanded for an NLP model to fully utilize all the information of the text. The contraction removal technique 522 may utilize one or more dictionaries or hash-maps from a pre-loaded database of contractions and map the contracted word from input data 510 to an expanded word or phrase, thus replacing the contraction with its associated mapping. For example, in the illustrated example, the term from input data 510 “I'll” may be modified to “I will.”

The tokenization technique 523 may be configured to split text input into one or more individual words. The tokenization technique 523 may take the form of a regular expression using one or more identifiers to divide the text input into individual words. In implementations, identifiers may consist of punctuation or spaces. For example, in the illustrated example, tokenization technique 523 may transform input data 510 into one or more individual words, resulting in one or more individual terms: “Hey”, “ . . . ”, “I'll”, “need”, “more”, “info”, “bout”, “the”, “newish”, “**”, “phone”, “connector”, “devise”.

The stemming technique 524 may remove one or more trailing characters of a word to isolate the root of the processed word. In implementations, the stemming technique 524 may take the form of a regular expression that may filter out common ending characters and phrases of words such as “s”, “ing”, “es”, etc. For example, in the illustrated example, the term “newish” of input data 510 may be processed into the term “new.”

The special character removal technique 525 may be configured to remove one or more special characters or symbols from the text input 510. In implementations, the special character removal technique 525 may take the form of a regular expression that may filter out identified special characters. For example, in the illustrated example, the special characters “**” may be removed from the text input 510.

The lemmatization technique 526 may be configured to map one or more words to a lemma, wherein a lemma may be a base dictionary form of a word. In implementations, the lemmatization technique 526 may take the form of a utilizing a database of key-value pairs to map a set of words to their respective lemmas. For example, in one configuration the utilized by the lemmatization technique 526 may have the key-value pair “cats: cat” where “cats” may be transformed “cat” of text input data “cats are nice.” In the illustrated example, the term “newish” from input data 510 may be transformed to “new.”

The annotation technique 527 may tag one or more words or a part of speech of the text input 510. In implementations, the annotation technique 527 may comprise tagging one or more words or phrases of input data 510 with one or more pre-defined words or data contained within an annotation database. For example, in one configuration an “introduction inquiry” tag may be applied to the text input, “Hey . . . I'll need more info bout the newish ** phone connector devise.” In other implementations, an annotation database may comprise one or more annotations for tagging words, sentences, phrases, or other language in association with a stage of a conversation (e.g., an introduction, an inquiry, a conclusion, a lead, an opportunity, etc.) As discussed herein, annotation technique 527 may facilitate training one or more predictive models to determine a correlation between input data 510 and one or more outcome events based on the stage of the conversation that the input data was received.

Various other text pre-processing techniques, such as a capitalization/de-capitalization technique, a removing/retaining stop words technique, and a mapping company-specific terminology technique, may be applied by standardization component 520. In some embodiments, capitalization/de-capitalization technique may comprise transforming characters of text input data 510 to lowercase characters. In some embodiments, the removing/retaining stop words technique may comprise removing all conjunctions from input data 510 in order to group individual ideas of text data. In some embodiments, the mapping company-specific terminology technique may comprise utilizing a database of key-value pairs to map a set of words or phrases to a respective domain or company specific standard form. For example, in one configuration the database utilized by the mapping company-specific terminology technique may have the key-value pair comprising a nickname for a product and an official product name or identifier. In implementations, the use of a product nickname in input data 510 may be transformed to the product's official name or serial identifier.

The standardization output 530 may comprise string tokens. String tokens may be an array of one or more words, phrases, or characters resulting from the application of one or more the text pre-processing techniques to input data 510 by standardization component 520. For example, in the illustrated example, input data 510 may be transformed to a plurality of tokens consisting of the words “hello”, “I”, “will”, “need”, “information”, “about”, “the”, “new”, “phone” “connector”, “device”. In certain implementations, standardization output may comprise a one or more features used by a predictive model as described herein.

The parsing analysis component 540 may receive standardization output 530 and comprise one or more additional text pre-processing and exploratory analysis techniques. The one or more specific text pre-processing and exploratory analysis techniques may include a word embeddings technique 541 and an n-gram technique. The n-gram technique, for example, may comprise one or more of a bigram technique 542, a tri-gram technique 543, and higher level n-gram techniques 544. In certain implementations, the one or more text pre-processing and exploratory analysis techniques may include a sentiment analysis technique 545 and other standard text pre-processing and exploratory analysis NLP techniques. The output of the parsing analysis component 540 may comprise one or more outputs from the text pre-processing techniques in the parsing analysis component 540. For example, the output of the parsing analysis component may be a vector containing one or more scores for each word of standardization output 530 or input data 510 corresponding to its relative importance to text input data and its correlation to one or more outcomes events.

In some embodiments, the word embeddings technique 541 may be configured to convert text into numerical representations. For example, the word embeddings technique 541 may take the form of a vectorization algorithm. To illustrate, the vectorization algorithm for the word embeddings technique 541 may assign a numerical representation or weight to one or more words based on a pre-trained model, such as a global vector for word representation (GloVe). Pre-trained GloVe models may facilitate analyzing aggregated word-word co-occurrences statistics throughout a corpus of words, such as all Wikipedia, resulting in linear substructures of a given word vector space. For example, in one configuration the vectorization algorithm may take the form of term frequency-inverse document frequency (TF-IDF) algortihm, which quantifies the importance of a word in relation to a document within a corpus of documents. As explained herein, a corpus may be a large and structured data set of text. In implementations, a corpus may be a structured data set of multiple string tokens that have been collected from a list of user inquiries or other forms of input as disclosed herein. In an example embodiment, the TF-IDF algorithm may comprise a process consisting of the cross product of the term frequency matrix and inverse document frequency matrix of text input data 510.

The bigram technique 542 may generate one or more sequences of two adjacent elements from a received token string. The bigram technique 543 may comprise an algorithm that parses through a token string and groups each two adjacent tokens together. In some embodiments, the trigram technique 543 may be a process of generating a sequence of three adjacent elements from a token string. For example, the trigram technique 544 may comprise an algorithm that parses through a token string and groups each three adjacent tokens together. In some embodiments, a n-gram technique may be a process of generating a sequence of n-adjacent elements from a token string, where n is a number greater than three. The higher degree n-gram technique 544 may comprise an algorithm that parses through a token string, grouping each n-adjacent tokens together until it reaches the end of the token string. The n-gram techniques are used in NLP text pre-processing as a simple and scalable way to account for the context of text input data. For example, the word “buy” in the two sentences “I will never buy this,” and, “I will definitely buy this right now,” may have opposite meanings when considering the preceding word in each respective sentence.

In some embodiments, the sentiment analysis technique 546 comprise a process of identifying and quantifying input data 510 to determine one or more qualitative features. The sentiment analysis technique may comprise a rule-based system that evaluates text based on a set of pre-defined rules. For example in one configuration, the sentiment analysis technique 546 may utilize a database of key-value pairs, to quantify the words of a given text input according to a sentiment score. The key-value pairs comprising of individual words as keys and an associated sentiment score as the value which would be an applied mapping to the text input.

The text pre-processing output 550 may be configured to be the input of a predictive model for regression or classification algorithms, as described herein. The text pre-processing output 550 may comprise output of one or more of the text pre-processing techniques of both the standardization component 520 and parsing analysis component 540. For example, in one configuration the text pre-processing output 550 may comprise the standardization output component 530, and the output of the sentiment analysis technique 546, or both. As described herein, the text pre-processing output may comprise one or more features used by one or more predictive models. In an example embodiment, the features may correspond to the content of individual messages or communications between the first entity and the second entity or agent.

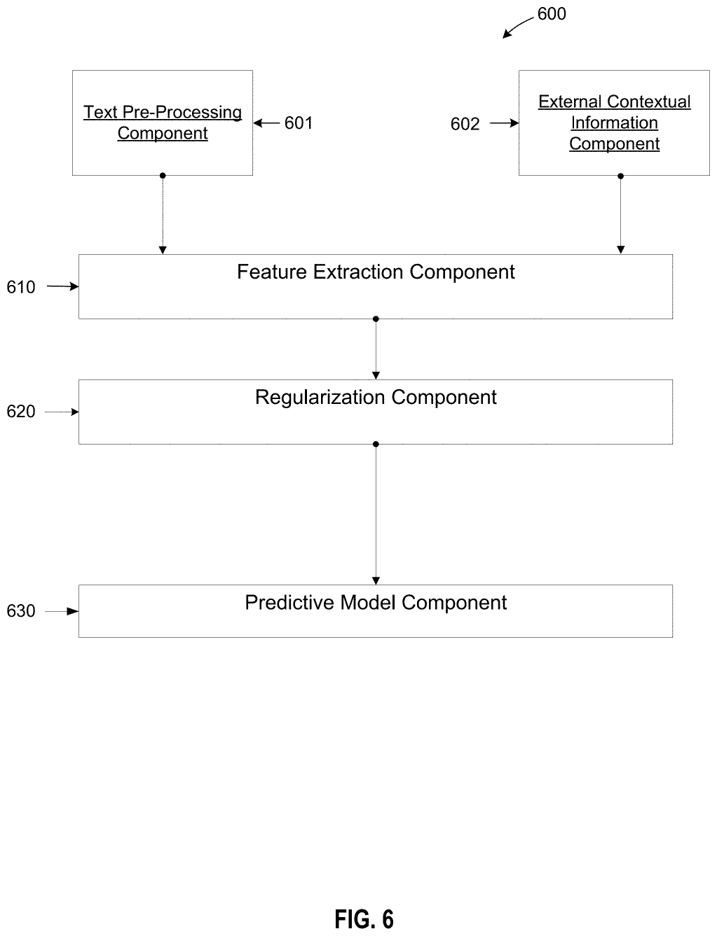

FIG. 6 illustrates an example block diagram 600 illustrating an example operation of a predictive model component 630. In example implementations, predictive model component 630 may be implemented in operation 314 of first communication phase component 118, in accordance with the embodiments disclosed herein. The operation of a predictive model component 630 may involve a text pre-processing component 500, external contextual information component 602, feature extraction component 610, regularization component 620, and predictive model component 630. The predictive model component 630 may comprise a first order predictive model trained to identify linear dependencies between features extracted during the first communication phase and one or more outcome events. In such embodiments, the predictive model component 630 may be effective in establishing linear dependencies between a limited amount of input received during a first communication phase and one or more outcome events for the purpose of agent assignment.

In some embodiments, the feature extraction component 610 may be configured to generate one or more values to facilitate the subsequent learning or classification of factors that affect an event-based outcome for human interpretation. The feature extraction component 610 may comprise a dynamic feature engineering algorithm based to determine the most influential variables associated with the output of predictive model 630. For example, in one configuration, the algorithm used by the feature extraction component 610 may be principal component analysis (PCA). Principal component analysis for example, may map the output of the one or more techniques of the text pre-processing component 500 and/or external contextual information component 602 to a lower-dimensional space in such a way that the variance of the data in the low-dimensional representation may be maximized. For example, if the sentiment analysis technique output directly correlates to the output of the word embeddings technique, one may be removed to lower dimensionality and increase efficiency of the first communication phase component.

In some embodiments, the regularization component 620 may be configured to constrain or “shrink” coefficient estimates of features towards a fixed numerical range, wherein a coefficient may comprise a weight or a numerical value associated with the importance of a feature . The regularization component 620 may comprise an algorithm that may normalize input to be in a specific range of numbers. For example, in one configuration, the regularization technique may be lasso regularization that constrains one or more feature values of the feature extraction component output. In implementations, a lasso regularization algorithm may be executed by the regularization component 620 by adding a penalty associated with the magnitude of the summation of the absolute value of feature coefficients. For example, if two features were extracted from the feature extraction component 610, the features had coefficients 5 and 10 respectively, and there was a penalty factor of −0.5, then the regularization component would add −0.5*(5+10)=−7.5 to each feature, thus transforming the coefficients for the two features to −2.5, 2.5 respectively.

A predictive model may use large coefficients for features that are significant factors in predicting probabilities, which may cause overfitting. Overfitting is a modeling error which occurs when a predictive model is based too closely on a limited set of data points usually by creating an overly complex model based on a peculiar data set. By reducing the absolute magnitude of a coefficient, as performed by regularization, overfitting may be reduced. As one of ordinary skill in the art would appreciate, various regularization techniques may be implemented to facilitate the digestion of information corresponding to input data received during the communication phases described herein.

In some embodiments, the predictive model component 630 may comprise a classification algorithm used to predict a probability of one or more outcome events based on received input data. In various implementations, predictive model 630 may comprise a multinomial logistic regression model. For example, in one configuration, the predictive model may perform a multinomial logistic regression on a regularized feature set to classify a feature into a category corresponding to its degree of correlation to one or more outcome events. For example, one or more first features extracted during the first communication phase may be categorized by the first predictive model into a low, medium, or high correlation category associated with its degree of correlation to one or more outcome events. In an example implementation, predictive model 630 may comprise a binomial logistic regression model configured to categorize one or more first features extracted during the first communication phase into a low or high correlation category associated with its degree of correlation to one or more outcome events. As discussed herein, the predictive model component may categorize one or more determined probability scores based on features into categories depending on whether the scores exceed one or more thresholds.

In various implementations, an outcome event may comprise the purchase of a product or service by the first entity. In such implementations, the degree of correlation between a feature and a sale may be categorized into one or more categories corresponding to a sales technique, a sales method, or a sales terminology. For example, input extracted and analyzed during the first communication phase may correlate to a sales “lead” or sales “opportunity,” whereby a sales lead indicates a medium degree of correlation between one or more features and a sale, and a sales opportunity indicates a high degree of correlation between one or more features and a sale. As discussed herein, the predictive model component 630 may comprise the first predictive model or second predictive model.

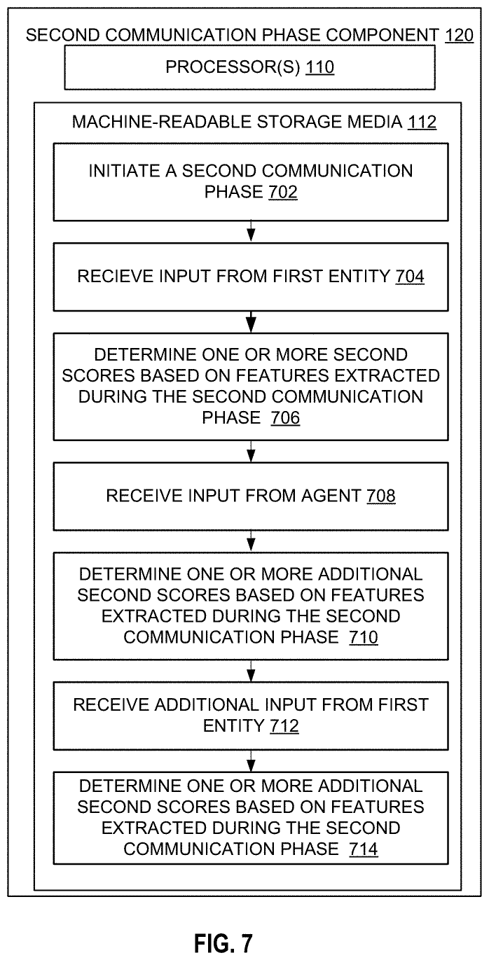

FIG. 7 illustrates an example embodiment of a process that may be performed by second communication phase component 120. In an embodiment, the method may be performed by one or more computing components 108, one or more processors 110, and a machine-readable storage media 112, as described herein.

As described herein, aspects of the disclosure may be directed to a process for determining and optimizing the probability of one or more outcome events based on a sequence of predictive analyses. A conversation between the first entity and the agent may comprise a sequence of one or more communications that may be individually analyzed for a determination of one or more scores corresponding to the probability of an outcome event. Thus, in accordance with the disclosure, one or more updated scores may be determined after at least one or more of: each sequential message that is exchanged between the first and second entity, each action of the first entity that results in a change in the external contextual information, a given period of time.

In some embodiments, processor(s) 110 may execute instruction 702 to initiate a second communication phase between the first entity and one or more agents assigned to the first entity. In implementations, the second communication phase may be pro-actively initiated by the second entity. For example, the second communication phase may be initiated by the second entity at the direction, command, or request of the second entity. In alternative implementations, the second communication phase may be reactively initiated by the second entity. For example, the second communication phase may be initiated by the second entity at the direction, command, or request of the first entity. In various implementation, for example, the second communication phase may be initiated at the selection of a first entity that selects an option indicating that the first has entity has responded to one or more of the specific information requests from the second entity. In other implementations, the second communication phase may be initiated by the second entity automatically after the first entity has provided input corresponding to responses to one or more of the information requests. In various implementations, the second communication phase may begin after the first entity has been assigned to one or more agents based on the one or more scores determined during the first communication phase.

In implementations of the disclosure, the second communication phase may comprise a communication environment configured to facilitate real-time communication between the first entity and the agent. In example embodiments, the first entity and the agent may communicate using text based messages, audio messages, or video messages. In implementations involving audio or video real-time conversations or messages, a voice-to-text method may be implemented to create text transcript data corresponding to real time communications.

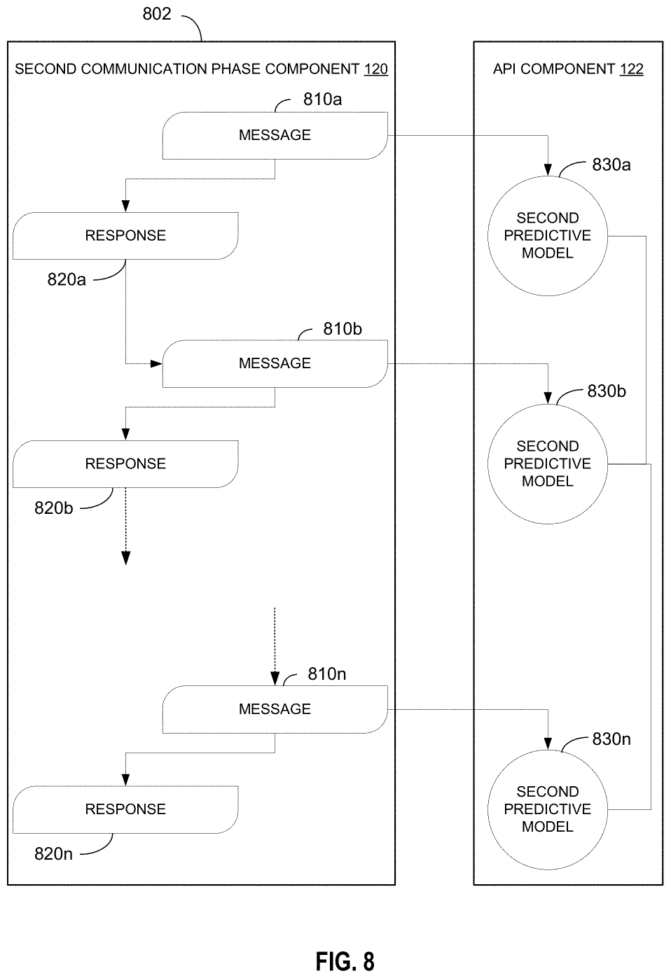

In some embodiments, processor(s) 110 may execute instruction 704 to receive input from the first entity. In embodiments, the second communication phase may enable a communication environment between the first entity and the agent configured to receive text input from the first entity. FIG. 8, for example, illustrates an example embodiment of a communication environment 802 that may be initiated by second communication phase component 802. In implementations, the first entity may provide text input in the form of a message 810a to the agent.

In some embodiments, processor(s) 110 may execute instruction 706 to determine one or more second scores based on features extracted during the second communication phase. As disclosed herein, the second communication phase component 120 may be configured to receive input from the first entity. Prior to the determination of the one or more second scores, step 706 may comprise extracting one or more features from input data. Various text-preprocessing and feature extraction techniques, as disclosed herein, may be applied to the one or more messages communicated between the first entity and one or more agents during the second communication phase to facilitate the determination of the one or more second scores.

In some embodiments, processor(s) 110 may execute instruction 706 to determine one or more scores corresponding to the probability of one or more of the outcome events based on one or more second features extracted during the second communication phase. The second predictive model may be configured to determine a score based on features contained within individual messages exchanged between the first entity and the agent. In implementations, the predictive model may be further configured to analyze features contained within two or more sequential or non-sequential messages exchanged between the first entity and the agent. As illustrated in FIG. 8, a second predictive model 830a may be applied to input corresponding to each sequential message received from the first entity. In embodiments, an API component 122 may be implemented to access the features or data obtained from or during second communication phase to facilitate the various text-preprocessing, feature extraction, and predictive analysis that may be performed by second entity as discussed herein.

In some embodiments, processor(s) 110 may execute instruction 708 to receive input from an agent corresponding to a response to input received from the first entity. As shown in FIG. 8, one or more responses 820 may be received from one or more agents assigned to the second communication phase for interaction with the first entity. In certain implementations, the one or more responses 820 from the agent may be displayed to the first entity on a device. In certain implementations, step 706 may comprising receiving and outputting text corresponding to a response 820a from the agent. In some implementations, an agent may be a person in communication with the first entity. In other implementations, an agent may be an artificially intelligent chat bot configured to communicate with the first entity. In accordance with the disclosure, step 706 may comprise receiving input from an artificially intelligent chat bot configured to communicate with the first entity and displaying, or otherwise communicating, the input to the first entity.

In some embodiments, processor(s) 110 may execute instruction 710, to determine one or more additional second scores corresponding to the probability of one more outcome events based on features extracted during the second communication phase. In various implementations, features may extracted from input data received from the first entity. In implementations, features may be extracted from external contextual information that may be obtained in real-time during the second communication phase. For example, after one or more scores are determined in step 706, the first entity may exhibit a behavior that may correlate to one or more of the outcome events, such as browsing to a new web page, hovering a mouse cursor over an image, or looking at a product that is displayed. Features may be extracted from such contextual information and analyzed in addition to features extracted from received input data to determine one or more scores corresponding to the probability of an outcome event (e.g., the sale of a product).

Features may be extracted and analyzed from input received from the agent to determine one or more scores corresponding to the probability of one or more outcome events. The probability of an outcome event involving an action by the first entity (e.g., the purchase of a product by the first entity) may be correlated to an agent's responses 820 to one or more messages 810 from the first entity. That is, the content of the agent responses 820 may influence the likelihood of an outcome event that is related to an action by the first entity. In a certain application of the disclosure, the agent may assist the first entity with a problem, such as a technical problem or questions. The communications exchanged between the first entity and agent during the second communication phase may reveal a high probability of one or more outcome events. In implementations, the agent may respond to one or more of the messages from the first entity to influence the probability of the one or more outcome events. For example, if the second predictive model determines after a few message sequences between the first entity and the agent that there is a high probability that the first entity will purchase a printer, then the agent may generate one or more responses 820 to increase the likelihood of the outcome event by, for example, providing information about the printers available for sale or asking whether or not the first entity owns a printer. In implementations of the disclosure, the agent's responses 820 to the first entity's messages may be analyzed by a predictive model to determine a correlation between features extracted from the agent's responses and the likelihood of one or more outcome events. As described herein, such analysis may be useful in determining the effectiveness of an agent's sales strategy or in training an artificially intelligent chat bot to optimize the probability of one or more of the outcome events.

In some embodiments, processor(s) 110 may execute instruction 712 to receive additional input from the first entity. As shown in FIG. 8, a second message from the first entity 810b may be received during the second communication phase. In implementations, an nth message 810n may be received during the first communication phase. For example, in operation 714, one or more additional second scores may be determined based on features extracted after additional input is received by the first entity. In embodiments, the contents of messages 810-810n may comprise free flow, natural conversational communication input. In contrast to the first communication phase, which may be configured to limit the input from first entity by soliciting responses to specific information requests, the second communication phase may be configured to receive unconstrained input from the first entity.

In implementations, the second predictive model may be trained to identify non-linear dependencies between one or more of the second features and one or more of the outcome events. In an example embodiment, and as discussed in more detail below, the second predictive model may comprise hierarchical neural network utilizing Long-Short Term Memory (LSTM) units to capture the long and short-term dependency among words and/or features that occur sequentially in a sentence, a plurality of sentences, or across two or more individual messages between the first entity and the agent. In such implementations, correlations between features extracted during the first communication phase and one or more outcome events may be determined on a message-by-message basis and at the conversation session level. That is, features extracted from two or more individual messages 810 received during the second communication phase may be analyzed as a group of messages to determine the one or more second scores. In such implementations, the overall intent of the first entity may be more effectively captured by analyzing entire conversational data, rather than only individual messages.

A benefit of the present disclosure is that a predictive analysis may be performed on input data after each sequential communication sequence to determine a change in the probability of one or more outcome events on a message-by-message or on a conversation session basis. In certain implementations, the scores determined by the second predictive model after each communication during the second communication phase may indicate, for example the effect that an agent's responses or communication have on the probability of one or more outcome events and may therefore inform a strategy to increase the probability of one or more outcome events.

In implementations, one or more scores corresponding to the probability of one or more event outcomes may be categorized, generalized, or grouped into a score type based on their relative magnitude. In implementations, scores that exceed a first threshold may be categorized, generalized, or grouped together, while scores that exceed a second, higher threshold may be grouped separately. In a non-limiting example, an outcome event may be defined as the first entity purchasing a product. In such implementations, one or more scores determined in the various steps of method 200 may correspond to the probability of a sale based on features extracted from the first and second communication phase. In an embodiment, if a determined score exceeds a first threshold (e.g., 50%), the first score may correspond to a “lead.” Further, if a determined score exceeds a second threshold (e.g., 95%), the score may correspond to a “opportunity.” In implementations, the score and the score type may be inform the sales agent as to the probability of the outcome event. In various implementations, and as discussed further below, one or more of the score and the score type may influence the agent's sales technique, strategy, or approach through a feedback mechanism in order the increase the probability of one or more outcome events.

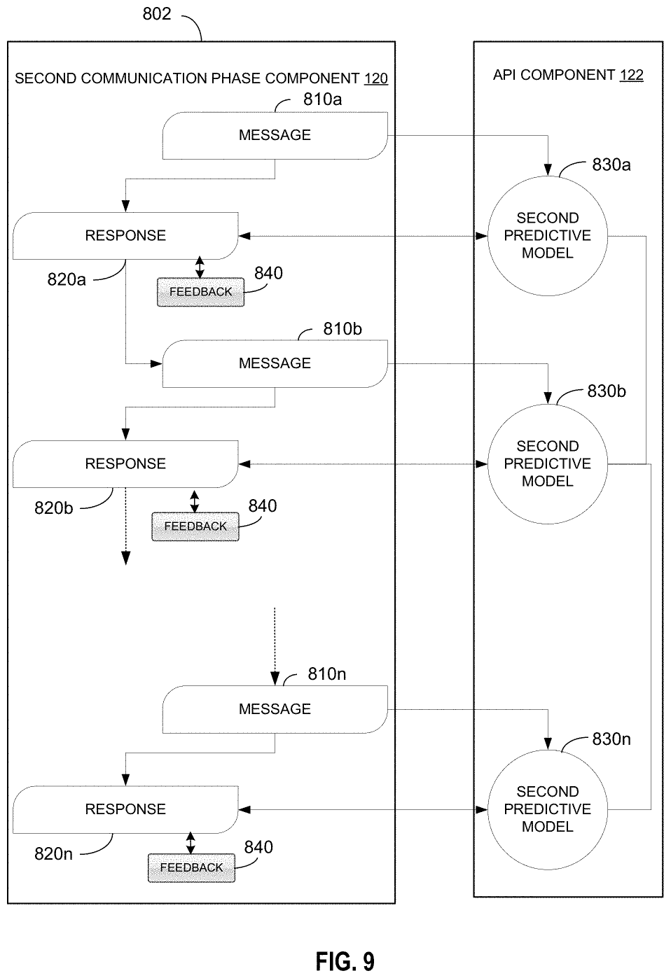

FIG. 9 illustrates an example of second communication phase component 802 utilizing a feedback component 840 configured to receive input corresponding to one or more outcome events. The various predictive models described herein may be machine learning models suitably trained on feedback and historical chat transcripts to increase accuracy in determine words or features that may be correlated to the generation of a sales lead, a sales opportunity, an actual sale, the absence of sale, or any other outcome event. As described herein, the second communication phase may be configured to facilitate a conversation between a first entity and one or more sales agents, wherein a predictive analysis may be performed after each communication to determine an updated score corresponding to the probability of one or more outcome events. Feedback component 840 may be configured to receive feedback corresponding to the occurrence of one or more outcome events.

As illustrated, feedback component 840 may use one or more messages or responses to suitably train one or more of the predictive models described herein. In implementations, features, communication data, words, strings, external contextual information, or any other information corresponding to the interaction between the first entity and either the second entity or the agent may be utilized by feedback component 840 to suitably train a predictive model. In implementations, manual feedback may be received by feedback component 840 for individual messages or responses. Features extracted from one or more responses from the agent may be used to train a model configured to generate responses during a communication phase to increase the probability of one or more outcome events.

In accordance with the disclosure, feedback may be provided to optimize, train, or modify, the various predictive models as described herein. For example, feedback as to the actual or suspected occurrence of one or more outcome events may be associated with input data from the one or more communication phases that preceded the occurrence of an outcome event.

Feedback component 840 may be configured to receive input corresponding to an outcome event from the first entity. For example, a user may provide input to select, purchase, add to a cart, or express interest in a product. The communication input data, such as messages during the first communication phase or second communication phase, that preceded the actual occurrence of the outcome event may be used to train the predictive models discussed herein. The conversations that preceded a sale of a certain product may be used as training data because such conversations may comprise words, features, and or characteristics that have strong correlations to the sale of the certain product.

Feedback component 840 may be configured to receive input corresponding to an outcome event from an agent. For example, an agent that is engaged in a second communication phase with a first entity as to the occurrence of an outcome event or the probability of an outcome event. For example, the agent may detect early on that the first entity is interested in purchasing a product or is interested in purchasing a product within a class of products. The agent may provide input received by feedback component 840 corresponding to the probability of the outcome event (i.e., a sale). For example, the agent may identify the first entity as a “lead” or as an “opportunity,” which may be used as input data to feedback component 840 to further train a predictive model. In certain implementations, an agent may provide input indicating that the first entity has made a purchasing decision. The words, communication, timing, or other features of the interaction between the agent and first entity may be used as training data for the predictive model.

The predictive models may be trained on all, or a portion of, the input data received for any given communication phase. In implementations, one or more thresholds may have been described to determine categorizations of certain outcome events, such as a lead or opportunity. In certain embodiments, training data with associated scores as described herein may be used as training data if the scores exceed or fall below an established threshold. For example, in certain implementations only the portion of the communication data preceding a determination as to the first entity's purchasing intent may be used as training data.

Data pertaining to the first entity, agent, and the relationship between the first entity and agent may be used as data to train a predictive model. As described herein, a first entity may have a user profile that contains identification, demographical, or behavioral information that may correspond to a user type. Information corresponding to a first entity may be useful in establishing correlations between communication information from various user types and one or more outcome events. Similarly, an agent may have certain attributes or characteristics, including a specialty or expertise that may be correlated to probability of an outcome event based on a given communication phase or user type of the first entity that is assigned to the agent. For example, an agent may have success in increasing the probability of an outcome event with certain types of first entities and certain products. Information pertaining to the participants of the various communication phases as described herein may be used as training data for the various predictive models described herein. In implementations, the predictive model utilized to determine scores for a communication phase may depend on the attributes, characteristics, or other information of one or more of the participants (i.e., a first entity or an agent).

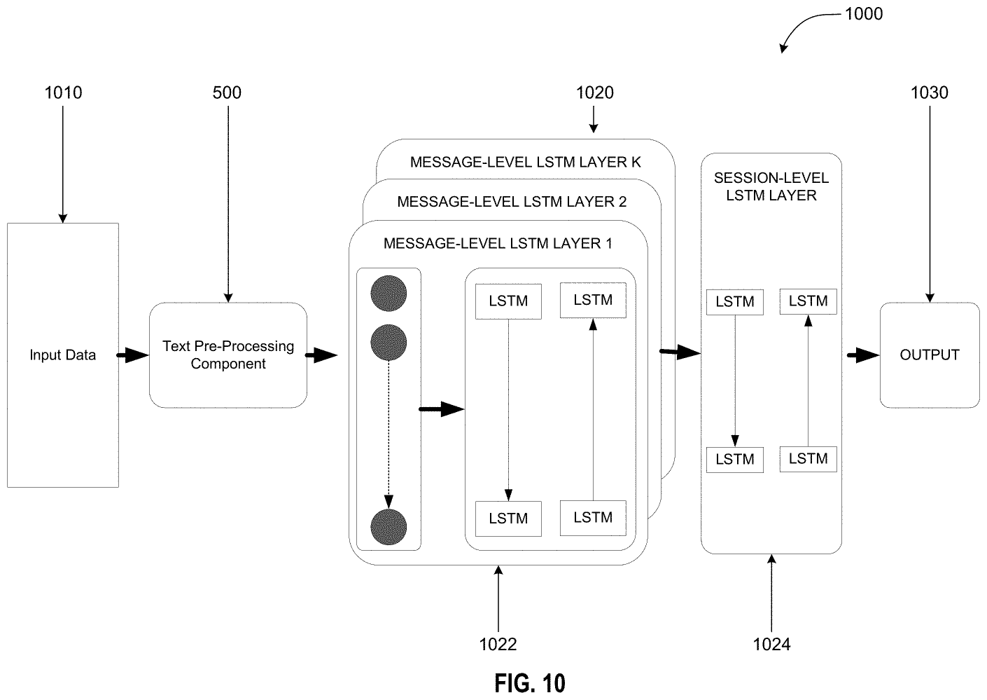

FIG. 10 illustrates an example of a second predictive model 1020 of the second communication phase component 120 in accordance with one or more of the embodiments disclosed herein. The predictive model 1020 may comprise one or more artificial neural networks configured to classify or perform regression on pre-processed or un-processed input data 1010.

Neural networks are computing systems inspired by the biological neural networks that constitute human brains. Neural networks may comprise an input layer, one or more hidden layers, and an output layer. Each layer may consist of one or more perceptron's commonly referred to as “nodes,” which may have an activation function that may be utilized to determine an output of a node given one or more inputs. In certain implementations, neural networks may be used to determine the probability of one or more outcome events given one or more inputs.

In implementations of neural networks, forward propagation may be utilized to determine an output corresponding to the probability of one or more outcome events. In certain implementations, forward propagation may be implemented by providing an neural network with one or more inputs, such as a feature, and performing a dot product operation between input values and one or more associated weights. The result of the dot product operation may be provided as input to an activation function. In a certain implementations, the activation function may be a sigmoid function. The resulting numerical value may be comparing to an actual output value to determine an error in the neural network prediction. In implementations, one or more of the weights utilized by the neural network may be changed to minimize the error. For example, a method such as backpropagation may be implemented to determine a gradient to calculate the optimal weights to minimize error in a neural network.

In implementations, second predictive model 1020 may be configured to process input data 1010 to determine one or more output scores 1030 corresponding to the probability of one or more outcome events. In certain implementations, input data may be processed by a text pre-processing component 500 employing various text pre-processing and/or feature extraction techniques as disclosed herein prior to being analyzed by the second predictive model 1020.

In implementations, input data 1010 may comprise messaging data communicated between a first entity and a second entity or a between a first entity and one or more agents. Input data 1010, for example, may take the form of a user interaction captured in a web based application. In one configuration, the input data 1010 may be in the form of a text input received in a window in a web application, such as communication environment 402. In other configurations, input data 1010 may comprise external contextual information, as described herein. For example, one or more words, sentences, image data, and or features of a webpage may form input data 1010. In some embodiments, the input data may be received by a text pre-processing component 500 or predictive model component 1020. Text pre-processing component 500 may comprise one or more various text-preprocessing techniques of the text pre-processing component 500 as described herein.

In implementations, the second predictive model 1020 component may comprise one or more long-short term memory (LSTM) networks. An LSTM network is a type of recurrent neural network, which are a specific class of neural networks where connections of the network may be coherent with a temporal sequence, such as a sequence of one or more communications as disclosed herein.

In certain implementations, predictive model component 1020 may comprise two different LSTM models used in conjunction to determine a prediction score output. In one configuration, the output of the one or more message-level LSTM layers 1022 may be used as input for the session-level LSTM layer 1024 to obtain a prediction score output 1030. In other configurations, message-level LSTM layers 1022 may be used directly to determine a prediction output of the prediction model component 1020. In one implementation, a message-level LSTM may provide a score corresponding to correlation between one or more outcome events and the content of a message. Additionally, a session-level LSTM layer may provide a score corresponding to correlation between one or more outcome events and the content of a plurality of sequential, or non-sequential messages, or an entire conversation.

In an embodiment, input data received during a communication phase in sequence may be provided to the second predictive model 1020. In certain implementations, text pre-processing component 500 may initialize the received input to be analyzed by the second predictive model 1020, as disclosed herein with respect to FIG. 5. For example, an embedding layer with weights initialized according to a pre-trained model (e.g., GloVe) may be utilized to prepare the input data to be analyzed by the second predictive model 1020.

In implementations, second predictive model 1020 may comprise a sequence of k message-level LSTM layers to emulate the structure of a chat conversation. In certain implementations, the k message-level LSTM layers may comprise one or more bidirectional LSTM layers. The one or more message-level LSTM layers 1022, for example, may take the form of a network of k bi-directional LSTM layers, where an input text data sequence may be provided to the first layer in the order the input text data was received and the second layer may be provided the input text data sequence in a reverse order. For example, each of the individual characters of a message, or features corresponding to the characters, may be analyzed by the message-level LSTMs layers both forwards and backwards. In implementations, the output of each of the message-level LSTM layers may be provided to a session-level LSTM layer 1024.

The session-level LSTM 1024 may comprise one or more LSTM layers. The session-level LSTM network 1024, for example, may take the form of one or more bi-directional LSTM layers. Each of the one or more bi-directional layers of the session-level LSTM network 1024 may comprise a first and second layer, wherein first layer may be provided the input text data sequence in the order the input text data was received and the second layer may be provided in a reverse order. For example, each message of a conversation, or features corresponding to the messaged, may be analyzed by the session-level LSTM layers both forwards and backwards.

The output 1030 may comprise on or more one or more scores corresponding to the probability of one or more outcome events. In implementations, one or more of the scores may fall into one or more predictive classifications associated with an outcome event or predictive probability statistics associated with an outcome event. The output 1030, for example, may take the form of a prediction score associated with a sale of a specific product or service. In one configuration the output component 1030 may be a lead prediction score and an opportunity prediction score. In an example embodiment, a lead prediction score may indicate that the first entity has a predicted intent to purchase a product, and an opportunity score may indicate that the first entity will purchase a product. In accordance with the embodiments disclosed herein, the categorization of a score as lead or opportunity score may depend on whether the score exceeds a threshold value.

FIG. 11 illustrates an example embodiment of an agent graphical 1100 user interface (GUI) designed to facilitate an interaction between an agent and a first entity and to optimize the probability of an outcome event. The agent GUI may be displayed, for example, on a display 1101 of a device. As described herein, the graphical user interface may comprise one or more selectable options, buttons, or other elements configured to receive input from a user that may be received by other components as discussed herein. In certain implementations, the graphical user interface may provide representations relating to information received during one or more of the communication phases as discussed herein. Graphical user interface may have access to such information, for example, by utilizing an application programming interface, such as application programming interface component 122. The various functions and operations described as being performed by agent GUI 1100 may performed by one or more components as discussed herein, including graphical user interface component 114. In a preferred embodiment, the agent GUI 1100 may be designed to be viewed, operated, or accessed by an agent during the second communication phase. The representation of the various elements of the agent GUI 1100, including the components of agent tool component 1130, is not intended to be limiting. The elements and components may be represented in various ways not shown in FIG. 11 or not visually represented at all.

Agent GUI 1100 may comprise one or more message windows 1100. A message window 1110 may provide representations of communications. In implementations, message window 1110 may provide representations of communications exchanged between the agent and the first entity during the second communication phase. For example, the one or more messages 1104 or responses 1102 exchanged between the agent and first entity may be represented by the agent GUI. In certain embodiments, messages and responses may be represented in substantially real-time as the messages or responses are received by the various components described herein.

As used herein, one or more visual aids may be implemented by the agent GUI 1100 to further increase agent engagement. For example, various colors, patterns, and effects may be implemented to distinguish information and represented by the agent GUI. Information that may be represented by the agent GUI may be distinguished based on one or more of the source of received input, the categorization of a score, the timing of a received input, and other examples discussed herein. A visual aid may consist of, at least, a change in color, a change in size, a change in a graphical effect used to introduce or remove a graphical representation, a representation used to divide, organize or categorize one or more scores, or other examples disclosed herein.

The various messages 1104 and responses 1102 of the message window 1100 may correspond to a conversation between a first entity and an agent comprising one or more stages. For example, a stage of a conversation may be one or more of an introduction, an inquiry, a conclusion, a lead, an opportunity, or any other conversation context consistent with the disclosure. Agent GUI may be configured to provide one or more representations of the stage that a certain conversation pertains to. For example, representation 1106 may indicate that the preceding messages 1104 pertain to an introduction, whereby messages after representation 1108 may indicate that following messages 1104 pertain to a conclusion. As disclosed herein, a predictive model may be configured to determine a stage of a conversation based on analyzed words or extracted features that may express a statistical correlation with a given communication stage. A predictive model may also consider the stage of the conversation in determining one or more scores corresponding to the probability of an outcome event. Agent GUI 1100 may be configured to provide insight into the probability of an outcome event by representing to the agent what the current conversation stage is (i.e., introduction, conclusion, lead, or opportunity). An agent may thus modify a communication strategy based on the stage represented by agent GUI 1100 to optimize the probability of an outcome event.

In implementations, agent GUI 1100 may comprise a plurality of message windows 1110 corresponding to a plurality of conversations between an agent and a plurality of entities. In an example embodiment, a sales agent may be interacting with several potential customers in different message windows. The representations of scores by probability tracker 1150 corresponding to the plurality or more messages windows 1110 may be represented simultaneously.

Agent GUI may comprise a probability tracker 1150 configured to provide representations of scores corresponding to the probability of one or more outcome events. Probability tracker 1150 may, for example, comprise an axis representing the value of a prediction score. For example, probability tracker may provide one or more representations of scores corresponding to the probability of one or more outcome events. Probability tracker 1150 may represent scores pertaining to different outcome events simultaneously. In certain implementations, probability tracker may implement a visual aid to distinguish scores corresponding to different outcome events.

Probability tracker 1150 may comprise an axis representing time. In certain implementations, the axis may represent time or may relate to the duration of a communication phase as described herein. For example, probability tracker 1150 may provide representations of scores according to the time one or more corresponding messages were received during a communication phase. In another example, probability tracker 1150 may provide representations of scores equidistance from each other in the order the one or more corresponding messages were received during a communication phase. In various implementations, probabilities corresponding to one or more outcome events may be plotted against time in a histogram for communications received from the first entity during a communication phase.

Probability tracker 1150 may be configured to represent one or more scores in substantially real time for communications received during a communication phase to increase agent engagement. As shown in FIG. 11, each message 1104 contained in message window 1110 may have a corresponding representation in probability tracker 1150. In certain implementations, probabilities determined based on agent responses 1102 may also have corresponding representations. In implementations, a visual aid may be used to illustrate the differences in scores determined based on agent responses 1102, first entity messages 1104, a combination of agent responses 1102 and first entity messages 1104, or any other input receivable by a predictive model as discussed herein. In accordance with the embodiments, an agent participating in a communication phase with the first entity may monitor scores calculated based on received input to visually observe a change in the probability of an outcome event after each exchanged message. Agent GUI 1100 may increase agent engagement because the agent is able to observe how the content of the conversation, or the content of the agent's communication specifically, is effecting the updating probability score. Thus, the agent is encouraged to focus attention to effect of agent responses 1102 and develop a strategy for modifying agent responses 1102 to increase a probability score.

The representation of scores corresponding to messages may be provided by the probability tracker 1150 in substantially real time. As described herein, one or more predictive models may determine one or more scores based on features extracted from one or more communication phases. Thus, there may exist a time delay between the time input is received during a communication phase and the time a determined score is represented by the agent GUI 1100 due to the processing required to determine and present the score. In implementations, scores may be represented by the agent GUI 1100 or probability tracker 1150 in sufficient time for an agent to observe the score before responding to a communication with the first entity.

Probability tracker 1152 may visually organize the represented scores based on a communication phase or a stage. As illustrated, probability tracker 1152 may organize representation of scores into respective sections for a first communication phase and a second communication phase. Dividing the representations of scores visually into different sections may increase agent attention by highlighting the effect of a communication phase transition on the represented scores. In implementations, agent GUI 1100 may implement a visual aid to distinguish the respective sections to provide clarity and ease of observation to an agent.

Probability tracker 1150 may also be configured to visually organize scores based on the value of the score. In implementations, scores may be categorized based on their value. As illustrated, messages M8 and M9 have a score that indicates a high degree (99% and 100%, respectively) of probability that an outcome event will occur. As shown, probability tracker may visually organize scores M8 and M into a respective section based on their value. To further illustrate, scores exceeding a first threshold (visually represented as 1152) may correspond to a sales lead, and scores exceeding a second threshold (visually represented as 1142) may correspond to a sales opportunity. In implementations of the invention, whether a score corresponds to a sales lead or sales opportunity may determine a visual aid used to represent the score or alter the representation of the score. In implementations of the invention, whether a score corresponds to a sales lead or sales opportunity may initiate a prompt corresponding to a component of the agent tool component.

Agent tool component 1130 may comprise one or more components designed to increase agent engagement and effectiveness. For example, agent tool component may comprise a feedback component 1131 for receiving feedback as described herein. For example, the agent may qualify the current stage of a conversation by providing input to the feedback component 1131 based on the agent's interaction with the first entity and understanding of the communication phase content. In various implementations, the agent may identify a conversation, message, or entity as a “lead” or “opportunity” based on the agent's perception or knowledge of the probability of an outcome event, such as a sale. As described herein, probability tracker 1152 may provide representations of scores, including one or more visual aids that correspond to the score's value. An agent can easily correct a predictive model's performance by providing feedback as to the agent's real-time understanding of the actual probability of an outcome event. Providing an agent a feedback component 1131 simultaneously with the probability tracker encourages prompt delivery of feedback because visual aids highlighting certain inaccurate represented scores may be more apparent to the agent.

Agent tool component 1130 may further comprise a session management component 1131. The session management component 1132 may be configured to provide an agent information about one or more sessions involving the agent. A session, for example, may be any communication phase or interaction with a first entity as described herein. In implementations, the session management component 1131 may provide representations of information pertaining to a score or categorization of a score. For example, the session management may represent to the agent that a first session corresponding to a first message window 1110 has “HIGH” correlation to an outcome event and a second session corresponding to a second message window 1110 has “MEDIUM” correlation to an outcome event. The session management component 1132 may provide information corresponding to a plurality of sessions simultaneously. By providing representations to the agent as to a session's status, the agent is able to more effectively allocate time and attention to certain sessions to optimize the probability of the outcome event for each individual session.

Agent tool component 1130 may further comprise a question recommendation component 1133. Response recommendation component 1133 may for example, provide questions or topics to the agent in order to increase or optimize the probability of an outcome event involving a first entity. As described herein, one or more responses from the agent, such as responses 1102, may be analyzed by a predictive model to determine a correlation to one or more outcome events. The various predictive models disclosed herein, through message and session level analysis, may provide insight into which responses or response types may be effective in increasing the probability of an outcome event based on the previous message 1103, the overall conversation content, or other input received during the first or second communication phase. In implementations, response recommendation component 1113 may provide an agent with a plurality of responses to select from. As disclosed herein, responses may be optimized by prompting the agent to provide feedback immediately after a recommend responses was used by an agent to further understand the response's effect on a score.

Response recommendation component 1133 may also be configured to recommend specific, predetermined questions based on the status of a given session. In implementations, response recommendation component 1133 may recommend specific, predetermined questions based on the value of the latest represented score in the probability tracker. In embodiments, the recommended responses may be specifically tailored to a lead or opportunity phase. In implementations, the recommended responses may pertain to the budget of the first entity; the authority of the first entity to make a purchase; the first entity's need for one or more products; or a time period for which the first entity needs one or more products. Such responses may be designed to optimize the probability of an outcome event or facilitate a transaction (i.e., gather necessary information for the completion of a sale). In implementations, the response recommendation component 1133 may prompt the user to provide certain responses based on score. In further embodiments, the response recommendation component 1133 may provide a representation of which recommended responses have been provided by the agent and which responses remain.

Agent tool component 1130 may further comprise a customer prioritization component 1134. Customer prioritization component 1134 may be configured to provide information pertaining to customer account of the first entity. As discussed herein, a first entity may have identification, demographical, behavior, and historical information associated a user or customer account. Such information may correspond to previous interactions with the second entity or agent, or to the actual occurrence of one or more outcome events involving the first entity, such as a sale. Customer prioritization component 1134 may be configured to provide customer account information, including but not limited to, whether the first entity is a returning customer, the shopping history of the user, an identification of products purchased by the first entity associated with the customer account, a score for the customer account corresponding to one or more determined scores involving the customer account, and other information pertaining to the customer account, including information about the first entity provided by third party data providers. In embodiments, the customer account prioritization component 1134 may provide an agent with relevant customer information to inform a sales strategy. For example, an agent may prioritize attention to a returning customer to provide better service to loyal customers, or prioritize a new customer over a previous customer with an extensive shopping history who may be considered highly likely to purchase a product.

Agent tool component 1130 may further comprise a product recommendation component 1135 to suggest certain products, or a classes of products, to the first entity. As disclosed herein, one or more scores determined during the first or second communication phase may correspond to the probability of the first entity purchasing a product or a class of products. Product recommendation component 1135 may one or more products, or a classes of products, if a determined probability score exceeds a given threshold. As disclosed herein, recommendations may be optimized by prompting the agent to provide feedback immediately after a recommend responses was used by an agent to further understand the response's effect on a score.

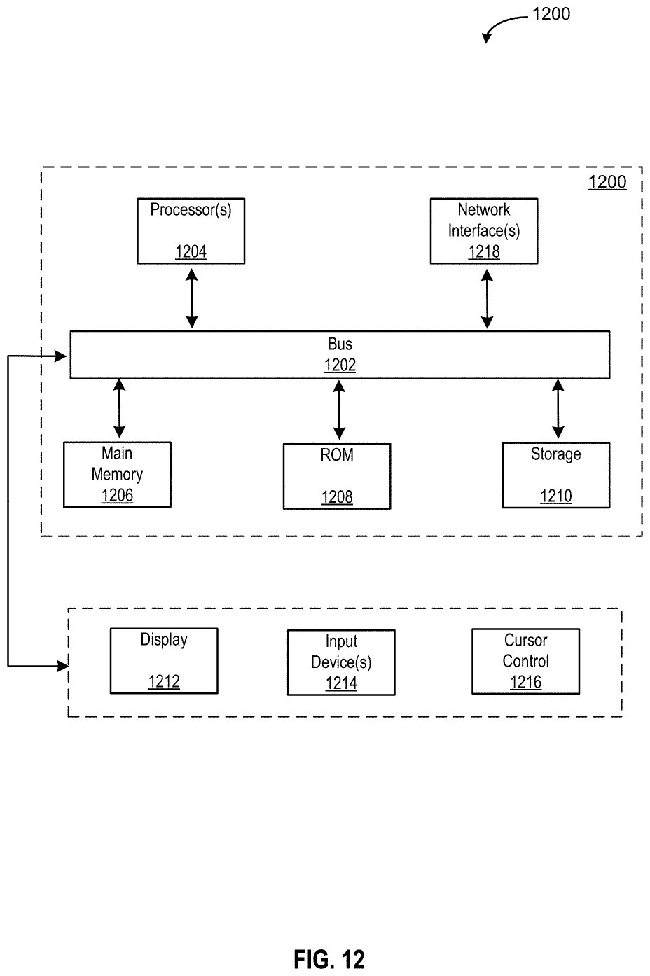

FIG. 12 depicts a block diagram of an example computer system 1200 in or by which various of the embodiments described herein may be implemented. The computer system 1200 includes a bus 1202 or other communication mechanism for communicating information, one or more hardware processors 1204 coupled with bus 1202 for processing information. Hardware processor(s) 1204 may be, for example, one or more general purpose microprocessors.

The computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions.

The computer system 1200 further includes a read only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

The computer system 1200 may be coupled via bus 1202 to a display 1212, such as a liquid crystal display (LCD) (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. In some embodiments, the same direction information and command selections as cursor control may be implemented via receiving touches on a touch screen without a cursor.

The computing system 1200 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts.

The computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor(s) 1204 executing one or more sequences of one or more instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1210. Volatile media includes dynamic memory, such as main memory 1206.

The computer system 1200 also includes a network interface 1218 coupled to bus 1202. Network interface 1218 provides a two-way data communication coupling to one or more network links that are connected to one or more local networks. For example, communication interface 1218 may be an integrated services digital network (ISDN) card, cable modem, satellite modem, or a modem to provide a data communication connection to a corresponding type of telephone line. As another example, network interface 1218 may be a local area network (LAN) card to provide a data communication connection to a compatible LAN (or WAN component to communicated with a WAN). Wireless links may also be implemented. In any such implementation, network interface 1218 sends and receives electrical, electromagnetic or optical signals that carry digital data streams representing various types of information.

The computer system 1200 can send messages and receive data, including program code, through the network(s), network link and communication interface 1218. In the Internet example, a server might transmit a requested code for an application program through the Internet, the ISP, the local network and the communication interface 1218.

The received code may be executed by processor 1204 as it is received, and/or stored in storage device 1210, or other non-volatile storage for later execution.

Terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Each of the processes, methods, and algorithms described in the preceding sections may be embodied in, and fully or partially automated by, software components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A computer-based method for predicting the probability of one or more outcome events based on message data, the method comprising the steps of:
determining, by applying a first predictive model, one or more first scores corresponding to the probability of one or more outcome events based on one or more first features extracted during a first communication phase between a first entity and a second entity;
assigning, by the second entity, the first entity to a conversation agent based on one of the one or more first scores;
initiating a second communication phase between the first entity and the agent, wherein the second communication phase comprises the steps of:
enabling a chat environment between the first entity and the agent configured to receive text input from the first entity;
receiving second communication phase text input from the first entity in the form of one or more sequential messages responsive to one or more messages from the agent; and
determining, by applying a second predictive model, one or more second scores corresponding to the probability of one or more of the outcome events based on one or more second features extracted during the second communication phase.

2. The method of claim 1, wherein an outcome event comprises one or more of:
the first entity purchasing any product;
the first entity purchasing a specific product;
the first entity making a purchase having a value above a defined threshold; and
the first entity purchasing a product within a defined class of products.

3. The method of claim 1, wherein assigning the first entity to the conversation agent is based on whether one or more of the first scores exceeds a predefined threshold.

4. The method of claim 1, wherein the first predictive model is a lasso logistic regression model trained to identify linear dependencies between one or more of the first features and one or more of the outcome events.

5. The method of claim 1, wherein the first communication phase comprises:
opening a chat environment configured to receive text input from the first entity;
receiving first communication phase text input from the first entity corresponding to one or more specific information requests from the second entity;
applying text preprocessing to the first communication phase text input; and
extracting one or more of the first features from the preprocessed first communication phase text input.

6. The method of claim 5, wherein the first communication phase further comprises extracting one or more of the first features from contextual information external to the chat environment.

7. The method of claim 5, wherein the one or more information requests from the second entity comprises one or more of:
a static form to be completed by the first entity;
a series of scripted questions from the second entity; or
an inquiry as to the intent of the first entity.

8. The method of claim 1, wherein the second communication phase further comprises the steps of:
applying text preprocessing to the second communication phase text input; and
extracting one or more of the second features from the preprocessed second communication phase text input.

9. The method of claim 1, wherein determining, by applying a second predictive model, one or more second scores corresponding to the probability of one or more of the outcome events based on one or more second features extracted during the second communication phase, comprises the steps of:
receiving a first text input from the first entity;
extracting one or more of the second features from the preprocessed first text input;
applying the second predictive model to determine one or more of the second scores based on the extracted second features of the first text input;
receiving a second text input from the first entity;
extracting one or more of the second features from the preprocessed second text input;
applying the second predictive model to determine one or more of the second scores based on the extracted features of the second text input; and
applying the second predictive model to determine one or more of the second scores based on the extracted features of the first text input and the second text input.

10. The method of claim 1, wherein the second predictive model is a hierarchical neural network trained to identify non-linear dependencies between one or more of the second features and one or more of the outcome events.

11. A system for monitoring and optimizing the probability of one or more outcome events based on message data, the system comprising:
a computing device configured to communicate with a first entity over a network, the computing device comprising a processor and a graphical user interface;
a non-transitory machine-readable storage medium comprising instructions executable by the processor;
a first communication phase component configured to calculate one or more first scores by applying a first predictive model, wherein the one or more first scores correspond to the probability of one or more outcome events based on one or more first features extracted during a first communication phase between a first entity and a second entity;
an assignment component configured to assign, by the second entity, the first entity to a conversation agent based on the one or more first scores;
a second communication phase component configured to calculate one or more second scores by applying a second predictive model, wherein the one or more second scores correspond to the probability of one or more of the outcome events based on one or more second features extracted during a second communication phase between the first entity and the agent; and
a graphical user interface component configured to display, on the graphical user interface, one or more representations of one or more of the first scores and one or more of the second scores.

12. The system of claim 11, wherein an outcome event comprises one or more of:
the first entity purchasing any product;
the first entity purchasing a specific product;
the first entity making a purchase having a value above a defined threshold; and
the first entity purchasing a product within a defined class of products.

13. The system of claim 11, wherein the first predictive model is a logistic regression model trained to identify linear dependencies between one or more of the first features and one or more of the outcome events.

14. The system of claim 11, wherein the second predictive model is a hierarchical neural network trained to identify non-linear dependencies between one or more of the second features and one or more of the outcome events.

15. The system of claim 11, wherein the second communication phase component is further configured to initiate an opportunity communication phase, wherein the opportunity communication phase is initiated after one or more of the second scores exceed a defined opportunity phase threshold.

16. The system of claim 15, further comprising:
a recommendation component configured to recommend, to the agent during the opportunity communication phase:
one or more information items to obtain from the first entity; and
one or more products to recommend for purchase by the first entity;

17. The system of claim 16, wherein the one or more information items correspond to one or more of:
the budget of the first entity;
the authority of the first entity to make a purchase;
the first entity's need for one or more products; and
a time period for which the first entity needs one or more products.

18. The system of claim 11, further comprising a feedback component configured to:
receive input from the agent during the second communication phase corresponding to the probability of one or more outcome events;
receive input corresponding to the actual occurrence of one or more outcome events; and
received input as feedback to the first predictive model or the second predictive model.

19. The system of claim 11, wherein the graphical user interface component comprises a probability tracker, wherein the probability tracker is configured to display the real-time probability of an outcome event for a plurality of sequential messages.

20. The system of claim 19, wherein the probability tracker is further configured to simultaneously display the real-time probability of a plurality of outcome events for a plurality of sequential messages.
